(19) United States
(12) Patent Application Publication
(10) Pub. No.: US 2004/0019539 A1
(43) Pub. Date: Jan. 29, 2004

(54) Prepaid billing system for wireless data networks

(75) Inventors: Sundar Raman, Arlington Heights, IL (US); Michael Borella, Naperville, IL (US); Chandra Warrier, Schaumburg, IL (US)

Correspondence Address: FITCH EVEN TABIN AND FLANNERY, 120 SOUTH LA SALLE STREET, SUITE 1600, CHICAGO, IL, 60603-3406, US

(73) Assignee: 3Com Corporation

(21) Appl. No.: 10/321,863

(22) Filed: Dec. 17, 2002

Related U.S. Application Data
(60) Provisional application No. 60/398,881, filed on Jul. 25, 2002.
(60) Provisional application No. 60/398,859, filed on Jul. 25, 2002.
(60) Provisional application No. 60/398,877, filed on Jul. 25, 2002.

(51) Int. Cl. G06F 17/60

(52) U.S. Cl. 705/29

(57) ABSTRACT

A method and apparatus for providing prepaid billing on a data network for wireless prepaid services, which includes a network-access device, such as a network access server or PDSN, that requests from a network-access-control device, such as a AAA server, network access for one or more wireless communication sessions. In response to the request for network access, the network-access device receives from the network-access-control device a block of credits and at least one measurement-method parameter. After being granted network access, the network-access device establishes session activity for the wireless communication sessions. The network-access device periodically measures usage of the session activity for the wireless communication session and then debits the usage of the session activity from the block of credits.

When the remain credits in the block of credits reach a predetermined threshold, the network-access device requests from the network-access-control device an additional block of credits. In responsive to this request, the network-access device receives from the network-access-control device the additional block of credits, if available credits remain in a cache of available credits from which the blocks are withdrawn. The network-access-control device may also receive the measurement-method parameters. The network-access device then debits the usage of the session activity for the wireless communication session from the additional block of credits.

At some predetermined threshold and responsive to an authorization to purchase credits, credits may be added to the cache of available credits. During this process, the ongoing wireless communication session may be redirected to a redirect device.

This application hereby claims the benefit of the following three previously filed and copending provisional applications:

No. 60/398,881 filed on Jul. 25, 2002

No. 60/398,859 filed on Jul. 25, 2002

No. 60/398,877 filed on Jul. 25, 2002

### BACKGROUND

1. Field of the Invention

The claimed invention relates to communications of computer networks. More specifically, it relates to a method and system for prepaid billing for wireless mobile services in communications networks.

2. Description of Related Art

In legacy prepaid billing scenarios, control of user access to the network is performed by elements of the Signaling System 7 (SS7) network. To enable such services, wired networks have adopted the advanced intelligent network (“AIN”) approach. The AIN approach provides for centrally located call control information and call processing logic, including the logic for prepaid billing, and a set of standardized messages between the network elements for accessing and using prepaid services, among other things.

Wireless telecommunications networks have been developed on a similar model. In some legacy wireless networks, the switching of calls and the signaling for call control may be performed by mobile switching centers (MSCs). Each MSC typically controls one or more base stations or base transceiver stations (BTSs), sometimes via one or more base station controllers (BSCs). Each BTS provides a wireless coverage area within which wireless mobile nodes, such as mobile phones, personal digital/data assistants, and other mobile devices, can communicate with the BTS over an air interface. Alternatively, the functions of the MSC may be integrated into or integral to the BSC, thereby eliminating the MSC. In such case, the functions performed by the MSC may be performed by one or more BSCs.

Each wireless mobile node typically has a “home” wireless network in which a home location register (HLR) serves as a centralized repository of information about the wireless mobile node. Typically, the HLR contains a user profile for the wireless mobile node, the last reported location of the mobile station, and the current status of the mobile station, such as whether it is active or inactive. The user profile may also contain indications or attributes of the enhanced services to which the wireless mobile node subscribes. Further, the user profile may be cataloged by the Mobile Identification Number (MIN), the dialed number, the Mobile Directory Number (MDN), the wireless mobile node's unique 32-bit Electronic Serial Number (ESN), or any other wireless mobile node identifier.

When an MSC (or alternatively a BSC) needs to find information about a wireless mobile node, such as where it is located or what services it subscribes to, it queries the HLR corresponding to that wireless mobile node. Thus, to inquire about a wireless mobile node prepaid services, the MSC or BSC queries the HLR.

In a manner analogous to the AIN approach used in wireline networks, an MSC or a BSC may also query a Wireless Intelligent Network (“WIN”) device for call processing instructions in the course of either originating a call from or terminating a call to the wireless mobile node. Such queries can arise from trigger points set by the wireless mobile node's service profile that the MSC or BSC downloaded from the wireless mobile node's HLR. Moreover, the MSC or BSC use such queries to obtain the call processing instructions needed to provide enhanced telecommunications services to the wireless mobile node. In response to such queries, the WIN network devices will typically execute the appropriate service logic and consult the wireless mobile node's service profile to formulate the call processing instructions that the WIN network devices then send to the MSC.

This is acceptable for voice services since the Home Location Register (HLR) controls authorization of voice services. Units of use in the voice networks are typically time-based. And since voice activity inherently involves the SS7 network, the draw down of the usage units is reported to the HLR on a regular basis, which can provide for reasonable accounting of the usage.

Today, second generation (“2G”) networks provide communication services to mobile nodes. These 2G networks have their foundation in older circuit-switched or packet-switched technologies that make the transmission of video and data quite slow, and thus, limit the type of multimedia, video and data services that can be used. In addition to the 2G networks, newer second-and-a-half generation (“2.5G”) network services are currently providing communication services to mobile nodes. These 2.5G networks use newer packet-switched services, which allow for increased transmission speeds for video and data as compared to 2G networks. Like the 2G networks, current 2.5G networks have similar limitations on the types of multimedia, video, and data services that can be used. Mobile nodes may take advantage of third generation (“3G”) network services, which allow for significantly faster data rates that in turn allow for a broader range of multimedia, video and data services to be used on a roaming mobile node. The 3G networks provide packet switched services with the capability of providing Internet Protocol traffic, such as Mobile Internet Protocol (“Mobile IP”) traffic; symmetrical and asymmetrical data rates; multimedia services such as video conferencing and streaming video; international roaming among different 3G operating environments; and more. Typical 3G systems include packet-based transmission of digitized voice, data and video. 3G networks encompass a range of wireless technologies such as Code Division Multiple Access (“CDMA”), Universal Mobile Telecommunications Service (“UMTS”), Wide-band CDMA (“WCDMA”), and others.

In 3G networks, communications originating and terminating from mobile nodes may use Mobile IP to establish a voice, video and/or data call from a mobile node that has roamed from its home network to a foreign network. Mobile IP allows mobile nodes to transparently move between different Internet Protocol sub-networks (“subnets”). For a mobile node to use the services of the network, it has to connect to its home subnet. The home subnet provides access to an external network, such as the Internet, through a “home agent” that serves as the subnet's gateway router.

To register on the 3G network, the mobile node may periodically transmit “agent solicitation” messages to the home agent. The mobile node also listens for “agent advertisement” messages from the PDSN. When a mobile node receives an agent advertisement message it registers with the PDSN that sent the agent advertisement message.

To provide services to the mobile node when the mobile node “roams,” (i.e., dynamically changes its physical location), the mobile node periodically transmits “agent solicitation” messages to other gateway routers, and also listens for “agent advertisement” messages from the other gateway routers. When a mobile node receives an agent advertisement message indicating that it is now on a foreign subnet, it registers with the foreign gateway router or “foreign agent,” and with its home agent. The registration with the foreign agent allows the mobile node to receive data on the foreign subnet. Whereas, the concurrent registration with the home agent provides an indication to the home subnet that the mobile node is not at home. This may allow for forwarding to the foreign subnet the data directed to the mobile node received on its home subnet.

As noted above, 2G and later networks provide packet data services in addition to the current voice services. Further, migration of voice services to a Voice over IP model complicates matters because the packet data network may and most likely will become the carrier for voice traffic, in contrast to the current circuit based mechanism, where voice traffic is controlled by SS7 and/or Wireless Intelligent Network (WIN) elements.

However, there are several problems associated with establishing voice, video or data calls on 3G networks. One problem is that users currently cannot easily buy, use or replenish prepaid services, such as pre-paid calling accounts on mobile nodes on some 3G networks. Such problems occur when legacy billing systems do not work on 3G networks, or the provider of the 3G networks access will not undertake providing 3G services to high-risk users. Further, without prepaid billing systems, large delays in receiving payments and/or bills can result in suspension or discontinuation of a user's 3G network services. And after fees are paid, it may be difficult for users of mobile nodes to re-establish service, when pre-paid billing systems are not implemented.

Moreover, without prepaid billing system in 3G networks, providers may have difficulty in disconnecting active users of mobile nodes when outstanding fees are owed. This difficulty is further complicated when the active users of the mobile nodes are constantly roaming from one foreign network to another because usage on each of the foreign networks may not be reported until a later date. In such case, it is possible for a user to overuse the amount of allotted network services. Conversely, users may be overcharged for actual usage if multiple network elements charger for the same service. While the aforementioned issues are common to both the data and voice services, the growth of data services and the demand for prepaid services in global markets will result in a need to satisfy these deficiencies.

Packet data traffic in the 3G networks are typically served to wireless mobile nodes by a Packet Data Serving Node (“PDSN”). The PDSN provides the same type of call control responsibility in the packet data network that the HLR provides in the circuit voice WINs network. Unlike the HLR, however, for the mobile nodes that it serves, packet data traffic may pass through the PDSN. Being in the packet-data-traffic path allows the PDSN to directly monitor and measure the usage of the wireless prepaid service. The PDSN need not be in the packet-data-traffic path, however, because the PDSN may receive usage information from another PDSN over a PDSN to PDSN link. Further details regarding inter-PDSN transfer are provided by co-pending U.S. application Ser. No. 10/097796, filed on Mar. 14, 2002, and titled “Method and System for Re-Direction and Handoff for Pre-Paid Mobile Services in Third Generation Networks,” which is fully incorporated herein by reference.

Current 3G network models presently suffer from having (i) no mechanism for tracking the consumption or usage of prepaid wireless services in near real time (e.g., most systems have monthly bill reconciliation); (ii) no mechanism for varying the measurement unit (in near real time) for the type of data, (e.g., time units for voice services and/or byte units for data services); (iii) no mechanism for scaling the usage measurement unit (in near real time) on foreign or brokered networks to provide “marking-up” or discounting of services when on a brokered network or foreign network; and (iv) no mechanism for providing usage units renewal during an ongoing communication session.

Thus, it is desirable to provide a method and system to support prepaid accounting and billing services that work correctly with mobile nodes on 3G networks.

### SUMMARY

According to one embodiment, a method for providing prepaid billing on a data network for wireless prepaid services may be carried out by a network-access device, such as a PDSN, requesting from a network-access-control device, such as a Network access AAA server, network access for a wireless communication session for one or more wireless mobile nodes. Responsive to the request for network access or registration, the network-access device receives from the network-access-control device for each wireless communication session a block of credits, which may be drawn from a user account having a cache of available credits. This block of credits may be less than all of the credits in the cache of available credits.

In addition, the network-access device may also receive one or more measurement-method parameters. These measurement-method parameters may include an indication for determining the usage units for the wireless communication session.

After receiving the block of credits and the measurement-method parameters, if any, the network-access device establishes session activity for the wireless communication session. Thereafter, the network-access device periodically measures usage of the session activity for the wireless communication session and debits the usage of the session activity from the block of credits, while the block of credits remains above a predetermined threshold.

In another embodiment, in response to receiving one or more measurement-method parameters from the network-access-control device, the network-access device selects one of a plurality of its predetermined-measurement methods for determining usage units for the wireless communication session. The measurement-method parameters passed to the network-access device from the network-access control device may include an indication for determining which of the plurality of predetermined-measurement methods the network-access device should select for determining the usage units for the wireless communication session. In an alternative arrangement, the measurement-method parameters passed to the network-access device from the network-access-control device may include an algorithm, conversion factor, and/or other instruction for determining the usage units for the wireless communication session. These measurement-method parameters may provide the network-access device with one or more methods for measuring the session activity of the wireless communication session.

The methods for measuring the session activity may be in terms of the time used, the time connected, the number of bytes received, the number of bytes transmitted, the number of packets received, the number of packets transmitted, and/or any other measurement method for communication services. By using these and other various measurement methods, the session activity usage units may be varied for the wireless communication sessions. These variations allow the network-access device to flexibly apply different and scalable usage units against the session activity for one or more communication sessions.

In another embodiment, the network-access device requests from the network-access-control device additional blocks of credits from which the network-access device can debit the usage of the session activity of the wireless communications session. The network-access device may make the request when a predetermined number of the credits remain in the block of credits or at some other predetermined threshold.

After the network-access-control device receives from the network-access device the request for the additional block or blocks of credits, the network-access-control device determines if enough credits remain in the cache of available credits to withdraw the requested additional block of credits. If available, the network-access-control device fulfills the request by sending to the network-access device the additional block of credits.

Additionally, the network-access-control device may send to the network-access device one or more measurement-method parameters, which may be the same or vary from those sent to the network-access device in conjunction with the first block of credits. After receiving from the network-access-control device the additional block or blocks of credits, the network-access device debits the usage of the session activity for the wireless communication session from the additional block or blocks of credits.

In another embodiment, instead of sending additional blocks of credits in response to the request for the additional block or blocks of credits, the network-access-control device sends to the network-access device a denial to the request for an additional block of credits. The network-access-control device may send the denial for a variety of reasons.

In response to the denial, the network-access device may terminate the session activity for the first communication (i) immediately, (ii) when no portion of block of credits remains, or (iii) at any other point. Alternatively, in response to the denial, the wireless communication session may be redirected to a second-network-access-control-device, such as a Redirect Server, for “keeping alive” the session activity during a process of purchasing credits, if such purchase is desired.

The process of purchasing and adding credits to the cache of available credits may be performed in various ways. In one embodiment, the network-access-control device sends to the network-access device parameters indicative of adding credits to the cache of available credits. These parameters may include (i) a denial to the request for a second or additional block of credits, (ii) an indication defining an attribute of the second-access-control device, and/or (iii) any other indication that indicates that no available credits remain. The parameters are used as a trigger for establishing a second wireless communication between the wireless mobile node carrying on the wireless communication session and the second-network-access-control device. This second wireless communication session is used to authorize a purchase of credits. In addition, the parameters may prompt the network-access device to redirect the wireless communication session to a redirect-network device for “keeping alive” the wireless communication session.

The redirection may last until credits are purchased, whereby, after the purchase, the wireless communication session continues as before; or alternatively, until the second-communication session is otherwise terminated, whereby the wireless communication session continues until no credits remain.

In response to receiving the parameters indicative of adding credits, the network-access device establishes a second wireless communication session between the user and the second-network-access-control device. After establishing the second wireless communication session, the second-network-access-control device sends to the network-access device information indicative of a payments account. The second-network-access-control device also sends to the network-access device a request to confirm charging the purchase of credits against the payments account The network-access device relays to the wireless mobile node the information indicative of the payments account and the request to confirm charging the purchase of credits against the corresponding payments account. If desired, the wireless mobile node (or the user thereof) sends a confirmation to charge the purchase of credits against the corresponding payments account. This confirmation provides the authorization to purchase credits. After receiving the confirmation, the second-network-access-control device charges the purchase of credits against the corresponding payments account and adds credits to the cache of available credits.

In an alternative embodiment, after the network-access device establishes the second wireless communication session, the wireless mobile node initiates the process of purchasing credits by sending to the second-network-access-control device information indicative of the payments account and an authorization to charge the purchase of credits against a corresponding payments account. In response, the second-network-access-control device charges the purchase of credits against the payments account and adds credits to the cache of available credits.

In yet another embodiment, when the cache of available credits reaches a predetermined threshold the process of purchasing credits begins. If the authorization to purchase credits involves user intervention, then after obtaining the information indicative of the payments account, the network-access-control device sends to the wireless mobile node (and the user thereof) the information indicative of the payments account and a request to confirm charging the purchase of credits against the corresponding payments account. In response to receiving the information indicative of the payments account and the request to confirm charging the purchase of credits, the user via the wireless mobile node sends to the network-access-control device a confirmation for charging the purchase of credits against the corresponding payments account, thereby authorizing the purchase of credits.

In response to receiving the confirmation, the network-access-control device relays it to the second-network-access-control device. After receiving the confirmation, the second-network-access-control device charges the purchase of credits against the corresponding payments account and adds credits to the cache of available credits.

Authorization to purchase credits might not involve user intervention, however. In one such case, the network-access-control device may initiate the process of purchasing credits by sending to the second-network-access-control device information indicative of the payments account and a request for charging the purchase of credits against the corresponding payments account.

The second-network-access-control device receives the information indicative of the payments account and the request for charging the purchase of credits against the corresponding payments account. The second-network-access-control device may send to the network-access-control device a request to confirm charging the purchase of credits against the corresponding payments account. When the network-access-control device receives the request to confirm charging the purchase of credits against the corresponding payments account, it may responsively reply with a confirmation for charging the purchase of the credits against the corresponding payments account. After receiving the confirmation, the second-network-access-control device charges the purchase of credits against the corresponding payments account and adds credits to the cache of available credits.

These as well as other embodiments will become apparent to those of ordinary skill in the art by reading the following detailed description, with appropriate reference to the accompanying drawings.

### BRIEF DESCRIPTION OF THE DRAWINGS

Preferred embodiments of the invention are described below in conjunction with the appended figures, wherein like reference numerals refer to like elements in the various figures, and wherein:

FIG. 1 is a block diagram illustrating an exemplary network system in accordance with an exemplary embodiment;

FIG. 2 is second block diagram illustrating an exemplary layered-protocol stack according to an exemplary embodiment;

FIG. 3 is a third block diagram illustrating an exemplary Mobile IP system according to an exemplary embodiment;

FIG. 4 is a fourth block diagram illustrating an exemplary data network according to an exemplary embodiment;

FIG. 5 is a fifth block diagram illustrating an exemplary portion of a data network according to an exemplary embodiment;

FIG. 6 is a flow diagram illustrating a method for providing prepaid billing for wireless prepaid services on a data network according to an exemplary embodiment;

FIG. 7 is a second flow diagram illustrating a method for providing prepaid billing for wireless prepaid services on a data network according to an exemplary embodiment;

FIG. 8a is a third flow diagram illustrating a method for providing prepaid billing for wireless prepaid services on a data network according to an exemplary embodiment;

FIG. 8b is a fourth flow diagram illustrating a method for providing prepaid billing for wireless prepaid services on a data network according to an exemplary embodiment;

FIG. 8c is a fifth flow diagram illustrating a method for providing prepaid billing for wireless prepaid services on a data network according to an exemplary embodiment;

FIG. 9 is a first call flow diagram illustrating an exemplary message flow according to an exemplary embodiment;

FIG. 10 is a second call flow diagram illustrating an exemplary message flow according to an exemplary embodiment;

FIG. 11 is a third call flow diagram illustrating an exemplary message flow according to an exemplary embodiment;

FIG. 12 is a sixth block diagram illustrating an exemplary portion of the 3G network using the DIAMETER protocol for AAA services according to an exemplary embodiment;

FIG. 13 is a fourth call flow diagram illustrating an exemplary message flow for a wireless prepaid call on a 3G network using the DIAMETER protocol according to an exemplary embodiment;

FIG. 14 is a fifth call flow diagram illustrating an exemplary message flow for a wireless prepaid call on a 3G network using the DIAMETER protocol according to an exemplary embodiment; and

FIG. 15 is a sixth call flow diagram illustrating an exemplary message flow for redirecting a wireless prepaid call on a 3G network using the DIAMETER protocol according to an exemplary embodiment.

### DETAILED DESCRIPTION OF EXEMPLARY EMBODIMENTS

1. Exemplary Architecture for Prepaid Billing

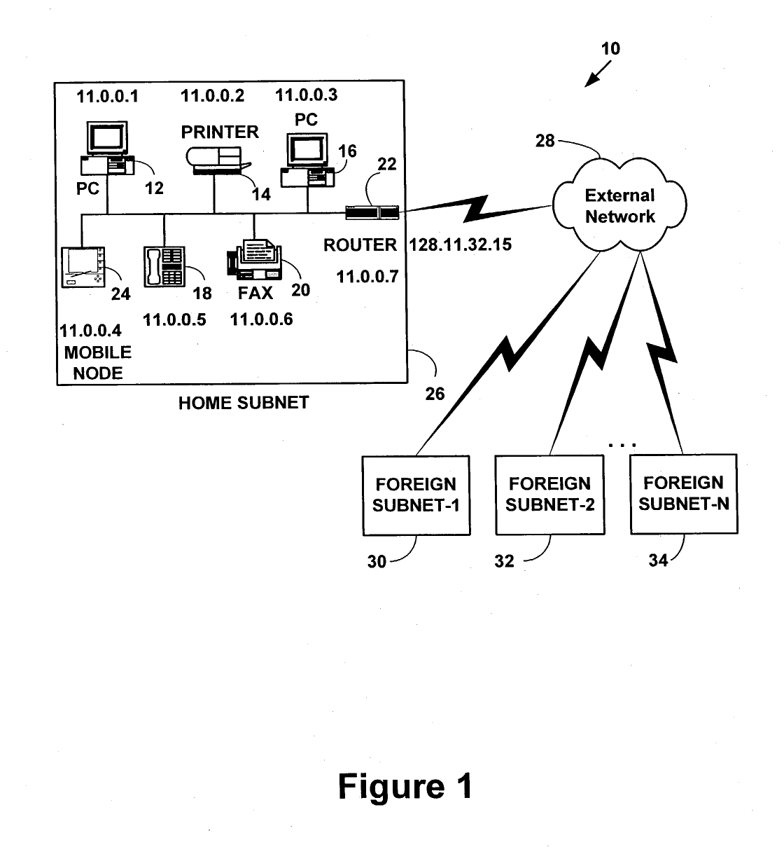

FIG. 1 is a block diagram illustrating an exemplary network system 10 in accordance with an exemplary embodiment. The network system 10 includes one or more local network devices 12, 14, 16, 18, 20, 22, 24. More or fewer local network devices can also be used. Each of the local network devices may be assigned network addresses (e.g., 11.0.0.x) on a local subnet 26. The local subnet 26 includes, but is not limited to, a wireless network, a wired network, a wireless or wired LAN, an optical network or a cable network. However, other computer networks can also be used.

The local subnet 26 is connected to an external network 28, such as the Internet or an intranet, via gateway router 22. The gateway router 22 may connect local subnet 26 to other computer networks using different networking protocols or operating at different transmission capacities. The gateway router 22 may also translate the data of a communication session between differing network protocols, and may provide for routing data (in the form of data packets) to an appropriate network node or network device. Local network devices on the local subnet 26 can reach one or more remote network devices on foreign subnets 30, 32, 34, via the external network 28.

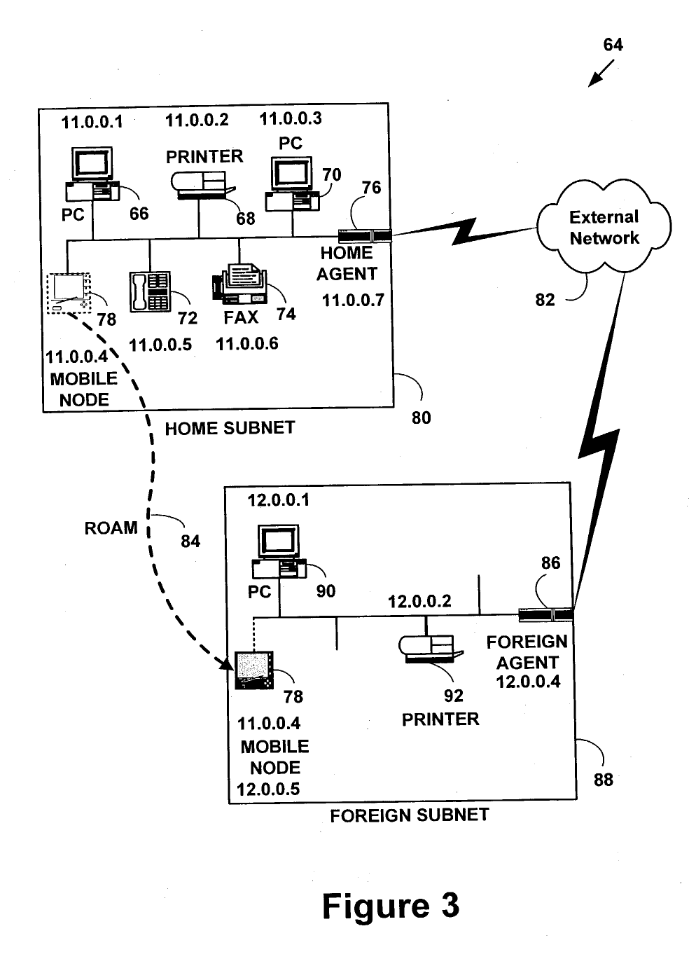

Exemplary network devices include those that can interact with network system 10 and with the exemplary mobile network system illustrated in FIG. 3. Further, these exemplary network devices can communicate with the system 10 and the system illustrated in FIG. 3 according to all or selected portions of standards proposed by (i) the Data-Over-Cable-Service-Interface-Specification (“DOCSIS”) standards from the Multimedia Cable Network Systems (“MCNS”), (ii) the Institute of Electrical and Electronic Engineers (“IEEE”), (iii) International Telecommunications Union-Telecommunication Standardization Sector (“ITU”), Telecommunications Industry Association (“TIA”), (iii) Internet Engineering Task Force (“IETF”), (iv) Wireless Application Protocol (“WAP”) Forum, The Third Generation Partnership Project 2 (“3GPP2”), and/or (v) the Third Generation Partnership Project (“3GPP”) standards. Network devices based on other standards, however, may also be used.

DOCSIS standards can be found on the World Wide Web at the Universal Resource Locator (“URL”) “www.cablemodem.com.” IEEE standards can be found at the URL “www.ieee.org.” The ITU, (formerly known as the CCITT) standards can be found at the URL “www.itu.ch.” TIA standards can be found at the URL “www.tiaonline.org.” IETF standards can be found at the URL “www.ietf org.” The WAP standards can be found at the URL “www.wapforum.org.” The 3GPP2 standards may be found at the URL “www.3gpp2.org.” The 3GPP standards may be found at the URL “www.3gpp.org.”

Each network device may contain a processing system with at least one high speed Central Processing Unit (“CPU”), data storage, and memory. Furthermore, an operating system may manage the resources of each network device. The data storage may include computer readable medium devices such as magnetic disks, optical disks, organic memory, and/or any other volatile (e.g., Random Access Memory (“RAM”)) or non-volatile (e.g., Read-Only Memory (“ROM”)) mass storage systems. The data storage may be concentrated or conversely, it may be distributed. Data maintained by network devices may be stored in the concentrated data storage as well as in the distributed data storage.

A. Exemplary Protocol Stack

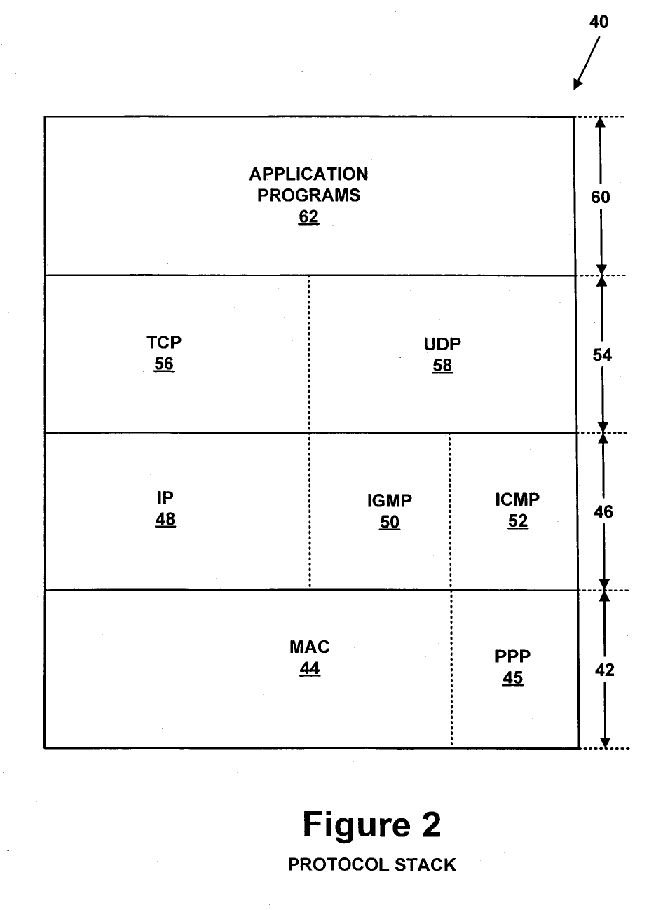

FIG. 2 is a block diagram illustrating an exemplary layered-protocol stack 40 for communication sessions originating and terminating from mobile and non-mobile network devices used in the exemplary network system 10 (FIG. 1) and in the exemplary mobile network system illustrated in FIG. 3. The layered-protocol stack 40 is described with respect to Internet Protocol (IP) suites comprising from lowest-to-highest, a link, a network, a transport and an application layer. The layered-protocol stack 40, however, may contain more or fewer layers may be used. Layer designations other than those of the IP suite may be used for the layers in the protocol stack 40, as well. For example, layering based on the seven layer Open Systems Interconnection (“OSI”)model may be used.

The layered-protocol stack 40 provides a way to connect one network device to another using an underlying physical transmission medium comprising a wireless network wired network, wireless or wired LAN, an optical network, a cable network, and/or any other computer network. The underlying physical transmission medium, which may be referred to as a physical layer (not illustrated in FIG. 2), defines the electrical and physical properties of an underlying transmission medium.

Link layer 42 provides a connection mechanism for network devices to the underlying physical transmission medium or physical layer. The link layer 42 includes a Medium Access Control (“MAC”) protocol layer 44, which controls access to the underlying transmission medium via a physical layer. For more information on the MAC layer protocol, see IEEE 802.3. IEEE 802.3 is fully incorporated herein by reference. Link layer 42, however, is not limited to the MAC layer protocol 44, and other link layer protocols may be used. (e.g., other IEEE 802.x protocols).

The link layer 42 also includes a Point-to-Point Protocol (“PPP”) layer 45 (referred to hereinafter as PPP 45). Generally, in operation, PPP 45 encapsulates higher-level protocols in PPP headers for transporting communications. PPP 45 may be used to provide dial-up access over a serial communications link, and to provide synchronous as well as asynchronous communications. Details on PPP 45 may be found at Internet Engineering Task Force (“IETF”) Request for Comments (“RFC”), RFC-1661, RFC-1662 and RFC-1663, all of which are fully incorporated herein by reference.

Above the link layer 42 is a network layer 46 (also called the “Internet Layer” for Internet Protocol suites). The network layer 46 includes an internet protocol (“IP”) layer 48, which uses an IP addressing protocol designed to route traffic within a network and between networks. IP layer 48 (referred to hereinafter IP 48) is described in IETF RFC-791, and is fully incorporated herein by reference. As will be described below, the IP 48 contains support for Mobile IP.

The network layer 46 also includes an Internet Group Management Protocol (“IGMP”) layer 50, an Internet Control Message Protocol (“ICMP”) layer 52. IGMP layer 50, hereinafter IGMP 50, is responsible for multicasting. For more information on IGMP 50, see IETF RFC-1112, which is fully incorporated herein by reference. ICMP layer 52, hereinafter ICMP 52, is used for Internet Protocol control. The main functions of ICMP 52 include error reporting, reachability testing (e.g., “pinging”), route-change notification, performance, subnet addressing and other maintenance. Details regarding ICMP 52 may be found in IETF RFC-792, which is fully incorporated herein by reference. ICMP 52 can be used without IGMP 50. Both ICMP 52 and IGMP 50 are not required in protocol stack 40.

The network layer 46 may also include a Generic Routing Encapsulation (“GRE”) layer (not illustrated). GRE is a protocol for performing encapsulation of data from one arbitrary network layer protocol in another arbitrary network layer protocol. Details regarding GRE may be found in IETF RFC-1701-1702, which is fully incorporated herein by reference.

Above network layer 46 is a transport layer 54. The transport layer 54 includes a Transmission Control Protocol (“TCP”) layer 56 and/or a User Datagram Protocol (“UDP”) layer 58. The TCP layer 56, hereinafter TCP 56, provides a connection-oriented, end-to-end, reliable protocol designed to fit into a layered hierarchy of protocols which support multi-network applications. TCP 56 provides for reliable inter-process communication between pairs of processes in network devices attached to distinct, but interconnected networks.

The UDP layer 58, hereinafter UDP 58, provides a connectionless mode of communications using datagrams in an interconnected set of computer networks. UDP 58 provides a transaction oriented datagram protocol, where delivery and duplicate packet protection are not guaranteed. Both TCP 56 and UDP 58 are not required in protocol stack 40. And either TCP 56 or UDP 58 can be used without the other.

Above the transport layer 54 is an application layer 60. The application layer 60 may include one or more application programs 62. These application programs 62 provide to a network device desired functionality, such as telephony or other communications functionality. The application programs 62 may include voice, video, audio, data or other applications. The application layer 60 may also include application-layer-protocol layers. These application-layer-protocol layers typically provide a subset of the functionality provided by an application program.

In one embodiment, the application layer 60 includes a Mobile IP application program 62. For Details regarding Mobile IP see “Mobile IP: The Internet Unplugged,” by J. D. Solomon, Prentice-Hall, 1998, ISBN-0-13-856246-6. See also Mobile IP, as defined by IETF RFCs 2002-2006, all of which are incorporated herein by reference.

The application layer 60 may also include a Dynamic Host Configuration Protocol (“DHCP”) application program 62, which provides a mechanism/standard for passing configuration information such as IP 48 addresses to network devices on an IP 48 network and other networks. For more information on DHCP see, RFC-1541, and RFC-2131 and RFC-2132, which are fully incorporated herein by reference.

The application layer 60 may also include a Service Location Protocol (“SLP”) application program 62, which provides a scalable framework for the discovery and selection of network services. Using SLP, network devices using the Internet need little or no static configuration of network services for network based applications. For more information on SLP see IETF RFC-2608, which is fully incorporated herein by reference.

The application layer 60 may also include a Session Initiation Protocol (“SIP”) application program 62, which is an application-layer 60 control protocol for creating, modifying, and terminating sessions with one or more participants. SIP sessions may include Internet multimedia conferences, Internet telephone calls (e.g., Voice over IP, “VoIP”), and multimedia distribution. Members in a SIP session can communicate via multicast or via a mesh of unicast relations, or a combination of these. SIP invitations used to create sessions carry SIP session descriptions, which allow participants to agree on a set of compatible media types.

SIP supports user mobility by proxying and re-directing requests to a mobile node's current location. Consequently, mobile nodes can register their current location. Furthermore, SIP is not tied to any particular conference control protocol. SIP is designed to be independent of a lower-layer transport protocols, and SIP may be extended. For more information on SIP, see IETF RFC-2543, “SIP: Session Initiation Protocol”, the contents of which are incorporated by reference.

The application layer 60 may also include ITU-T H.323 or H.324 application programs 62. H.323 is the main family of video conferencing recommendations for IP networks. The ITU-T H.323 standard is fully incorporated herein by reference. H.324 is a video conferencing recommendation for using plain-old-telephone-service (“POTS”) lines. The ITU-T H.324 standard is incorporated by reference.

The application layer 60 may also include a VoIP application program 62, which in turn may include several other application programs 62, such as H.323 and SIP. The VoIP application program 62 converts a voice signal into a stream of packets, such as IP 48 packets, for transmission into a packet network. The VoIP application 62 may also convert the stream of packets back into a voice signal.

VoIP services typically provide connectivity to traditional circuit-switched voice networks. As noted above, VoIP is typically used with the H.323 protocol and other multimedia protocols. H.323 terminals such as multimedia computers, handheld devices, personal digital/data assistants (“PDA”) or other devices, such as mobile phones connect to existing wired and wireless networks, such as PSTNs, private wired and wireless networks, and public wireless networks.

H.323 terminals may be LAN-based end terminals for voice transmission. H.323 terminals may support real-time, two-way voice communications. H.323 terminals implement voice transmission functions and may include at least one voice Coder-Decoder (“CODEC”) for sending and receiving packetized voice. Examples of such CODECs include (i) Pulse Code Modulation (PCM), (ii) Adaptive Differential Pulse Code Modulation (ADPCM), (iii) Code-Excited Linear Predictive (CELP), (iv) Adaptive Code-Excited Linear Predictive (ACELP), (v) Relaxed Code-Excited Linear Predictive (RCELP), (vi) Selective Mode Vocoder (SMV), (vii) Linear Predictive Coding (LPC), (viii) Sinusoidal Transform Coder (STC), (ix) Improved Multiband Excitation (IMBE), (x) CDMA Qualcomm Code-Excited Linear Predictive (QCELP), (xi) CDMA4000-SMV, (xii) Adaptive Multirate GSM (AMR-GSM), (xiii) Federal Standard 1017, (xiv) IS-54, (xv) IS-641, and/or other CODEC, such as those found in ITU-T CODECS, G.711,G.723,G.726,G.728,G.729.

The application layer 60 may also include a Domain Name System (“DNS”) application program 62, which provides replicated distributed secure hierarchical databases for hierarchically storing resource records under domain names. The application layer 60 may also include an Authentication, Authorization, and Accounting (“AAA”) application program 62. AAA application programs 62 provide a classification scheme and exchange format for providing accounting data records (e.g., for call billing, etc.). For more information on AAA applications, see, “Accounting Attributes and Record Formats,” IETF RFC-2924, the contents of which are fully incorporated herein by reference.

AAA applications include, but are not limited to, “Remote Authentication Dial In User Service (RADIUS)” described in IETF RFC-2865, or the DIAMETER protocol, which is used for AAA for Mobile-IP, described in IETF draft <draft-calhoun-diameter-impl-guide-04.txt>entitled “DIAMETER Implementation Guidelines,” July 2000, and IETF draft <draft-calhoun-diameter-mobileip-11.txt>, entitled “DIAMETER Mobile IP Extensions,” September 2000, all of which are incorporated herein by reference. Other protocols or implementations, and other or equivalent AAA protocols can be used as well.

The application layer 60 may also include a Simple Network Management Protocol (“SNMP”) application program 62, which is used to support network management functions. For more information on SNMP layer 62 see IETF RFC-1157, which is fully incorporated herein by reference.

In one embodiment, one or more of network devices may be configured as act as an application server by distributing one or more of the application programs 62 among the network devices. In another embodiment, a single network device may be the application server. Examples of such application servers include SIP servers, H.323 servers, AAA servers, DNS servers, VoIP servers, and/or any other type server. In such an embodiment, network devices may include only an application program layer (e.g., SIP) that communicates with an application program (e.g., SIP) running on the stand-alone application server to provide application functionality. Other or equivalent embodiments may be used as well.

B. Mobile IP

Mobile IP allows “mobile” nodes to transparently move between different IP sub-networks. Mobile IP allows a mobile node to dynamically change its network connectivity in a manner that is transparent to protocol layers above the network layer 46 (e.g., TCP 56 or UDP 58). In an exemplary embodiment, support for Mobile IP application programs 62 or Mobile IP application layers is included in the IP 48 layer.

FIG. 3 is a block diagram illustrating an exemplary Mobile IP system 64. The Mobile IP system 64 includes one or more “non-mobile” network devices 66, 68, 70, 72, 74, 76, and a mobile node 78. Hereinafter the mobile node 78 is called “mobile node 78.” The Mobile IP System 64, however, may include hundreds or thousands of mobile nodes. More or fewer non-mobile network devices and more mobile nodes may be used as well.

The non-mobile network devices 66, 68, 70, 72, 74, 76, and the mobile node 78 are assigned a network addresses, such as IP 48 addresses on a home subnet 80. The home subnet 80 may include a wireless network, a wired LAN, an optical network, a cable network, and/or other computer network. The home subnet 80 is communicatively coupled to an external network 82, such as the Internet or an intranet, via a home agent (“HA”) 76. The HA 76 may provide a “gateway router” function for the home subnet 80.

When mobile node 78 “roams” 84 from its home subnet 80, it periodically transmits Mobile IP “agent solicitation” messages to foreign agents, such as foreign agent (“FA”) 86 via external network 82. The FA 86 is foreign with respect to home subnet 80 and resides on a foreign subnet 88 along with one or more foreign non-mobile network devices such as non-mobile network device 90 and 92. The foreign subnet 88 may also include one or more mobile nodes (not illustrated). Like the HA 76, the FA 86 provides a gateway router function for the foreign subnet 88. The foreign non-mobile network devices 90 and 92 are assigned network addresses, such as IP 48 addresses, on the foreign subnet 88.

In addition to transmitting “agent solicitation” messages while roaming, mobile node 78 listens for Mobile IP “agent advertisement” messages from foreign agents, such as such as FA 86. When roaming, mobile node 78 receives an agent advertisement message from FA 86 indicating that it is now on a foreign subnet 88. At some point, the mobile node 78 registers with the FA 86 and the HA 76. By registering with a HA76, the mobile node 78 notifies the HA76 that it has roamed 84 away from its home subnet 80.

On home subnet 80, mobile node 78 has a network address, such as IP 48 address 11.0.0.4., and the HA 76 has a network address, such as IP 48 address 11.0.0.7. Mobile and non-mobile network devices having network addresses beginning with a network access prefix of 11.0.0 and a prefix length of 24 bits (i.e., 11.0.0.X/24) belong to home subnet 80. Since the HA 76 is advertising a route to the home subnet 80 at 11.0.0.X/24, it will accept data packets from external network 82 for network addresses with the network access prefix 11.0.0.X/24. For example, the HA 76 may accept data packets for the mobile node 78, given that the home network address of the mobile node 78 is of 11.0.0.4.

The FA 86, on the other hand, has a network address of 12.0.0.4 on the foreign subnet 88. The FA 86 advertises a route to the foreign subnet 88 with network access prefix length of 12.0.0.Y/24. Thus, FA 86 will accept data packets that have a network address of 12.0.0.Y/24 on the foreign subnet 88. For example, the FA 86 will accept data packets for the non-mobile network devices 90 and 92 having a network address of 12.0.0.1. and 12.0.0.2., respectively.

The mobile node 78 uses its home network address of 11.0.0.4 on the home subnet 80 to register with the FA 86 and the HA 76. After registration of the mobile node 78, the FA 86 will also accept data packets for the mobile node 78 at the specific home network address 11.0.0.4 as well as data packets that have a network prefix of 12.0.0/24. THIRD GENERATION MOBILE ARCHITECTURE

Third-generation (“3G”) architecture supports data rates ranging from about 144K bits-per-second to about 2M bits-per-second, (“bps”) packet switched services. As noted above, 3G networks encompass a range of wireless technologies including Code Division Multiple Access (“CDMA”), Universal Mobile Telecommunications Service (“UMTS”) Wide-band CDMA (“WCDMA”), and others.

The ITU-T guidelines for 3G networks are included in the IMT-2000 standard. The ITU-T IMT-2000 standard is incorporated herein by reference. See also, the TIA TSB115, Wireless IP Network Architecture standard, TIA IS-835, Wireless IP Network Standard, and IS2000 and IS2001 standards for CDMA2000, the contents of all of which are incorporated by reference.

3G networks implementing IS2000 and IS2001 allow mobile nodes to roam from network-to-network using Mobile IP. Many of these mobile nodes may be wireless phones, wireless PDAs, or similar devices that need to establish, maintain, and terminate call or communication sessions. Call control protocols, such as SIP or H.323, may be used for session control. These call control protocols may allow a local proxy to be used on foreign networks so that local policy and/or bandwidth management can be applied to local and remote sessions. In the current generation of 3G networks, a local proxy is typically used on all foreign networks. A local proxy may be included in the FA 86 or in a stand-alone local proxy server or application program on the foreign network 88.

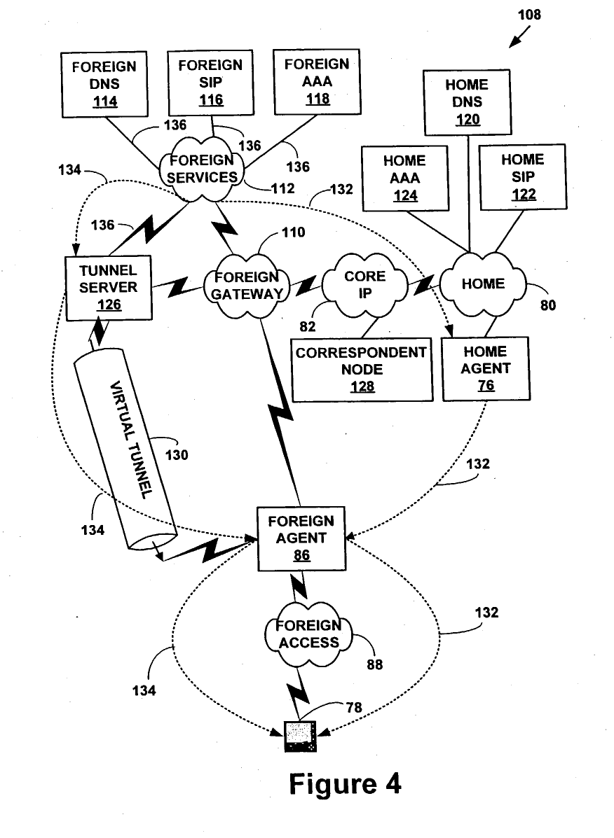

FIG. 4 is a block diagram illustrating an exemplary 3G system 108. The exemplary 3G system 108 includes a foreign gateway network 110, a foreign services network 112, a foreign DNS application 114, a foreign SIP application 116 and a foreign AAA application 118. The exemplary 3G system 108 also includes a home DNS application 120, a home SIP application 122, a home AAA application 124, a tunnel server (“TS”) 126 and a correspondence node (“CN”) 128. Other embodiments having more, fewer or other components may also be used in 3G system 108.

The home DNS application 120, home SIP application 122, home AAA application 124, tunnel server 126 and correspondence node 128 are illustrated as separate components. In other embodiments, all or selected ones of these components may be combined into a single or smaller number of components. For example, some of the other components may be integrated into HA 76

The foreign gateway network 110 and foreign services network 112 are illustrated as separate from foreign network 88. The foreign gateway network 110 may include an IP 48 network or other network, the foreign services network 112 may include (i) an IP 48 network, (ii) a Public Switched Telephone Network (“PSTN”), (iii) a packet data serving node (“PDSN”), and/or (iii) other network or network device. In one embodiment, the FA 86 is associated with a PDSN. Other types of foreign agents may be used. Further, the foreign gateway network 110 and the foreign services network 112 may all be integral to foreign network 88.

In an exemplary embodiment, the foreign gateway network 110 and the foreign services network 112 may be integral to foreign network 88. Alternatively, the foreign network 88, foreign gateway network 110 and foreign services network 112 are separate networks, as shown. For simplicity, the separate foreign networks are collectively referred to as “foreign network 88.”

Generally, a PDSN is a required component in most, but not all 3G networks 108. For mobile node 78, a PDSN is the point of entry into the wireless packet data network. The PDSN performs two basic functions: (1) it exchanges packets with mobile node 78 over a wireless network; and (2) it exchanges packets with other IP 48 networks. The PDSN uses associated AAA servers for user authentication and traffic management. Further, the PDSN forwards traffic to a gateway router/home agent (GR/HA) at the designated IP network. Other network access devices or servers may carry out the functionality of a PDSN, as well.

The PDSN may be coupled with a Packet Control Function (“PCF”). The PCF separates multiple IP 48 data transmissions and connects them to a core IP infrastructure 82. A PCF allows mobile VoIP and IP multimedia calls to continue through the core IP network 82.

The exemplary 3G system 108 also includes a virtual tunnel 130, a default communications path 132 a new communications path 134, and a tunnel server communications path 136. The default communications path 132 includes a communications path from the foreign services applications 114, 116, 118 on a foreign network to the HA 76 on the home network 80 to the FA 86 on the foreign network 88, and on to the mobile node 78 on the foreign network 88. The new communications path 134 includes a communications path from the foreign services applications 114, 116, 118 to the tunnel server 126 on a foreign network to the FA 86, and on to the mobile node 78 on the foreign network 88. The tunnel-server-communications path 136 includes a communications path or a reverse communications between the foreign service applications 114, 116, 118 and the tunnel server 126.

Also illustrated in FIG. 4 is HA 76, mobile node 78, home network 80, external network 82, FA 86 and foreign network 88 as described above (see FIG. 3). The home network 80 and the foreign network 88 may be a wireless network, a LAN, an optical network, a cable network, and/or other equivalent computer network.

FIG. 4 illustrates only one FA 86. In most implementations, however, plural FAs are used since large numbers of mobile nodes are supported. Further, the exemplary 3G systems may contain more, fewer or equivalent components.

In one embodiment, the exemplary 3G system 108 includes an all IP 48 network comprising of an IP 48 radio access network (“IP-RAN”), a PDSN, a PCF and an IP Mobility Core Network 82. Other embodiments with more or fewer components may also be used. These exemplary networks may support 2G, 2.5G and 3G wireless interface technologies including Code Division Multiple Access 95 or 2000 (“CDMA95” or “CMDA2000”), Global System for Mobile Communications, (“GSM”), Generic Packet Radio Services (“GPRS”), Personal Communications Services (“PCS”), a Cellular Digital Packet Data (“CDPD”), Wireless Application Protocol (“WAP”), Digital Audio Broadcasting (“DAB”), Bluetooth, 802.11a, Wireless LAN, Wifi/802.11b, or other types of wireless network interfaces. These multigenerational wireless interface technologies support telephony, Short Message Services (“SMS”), paging, voice mail, call forwarding, faxing, caller ID, Internet access, and e-mail, to name a few of the services available.

C. Mobile Node Communication in a 3G Network

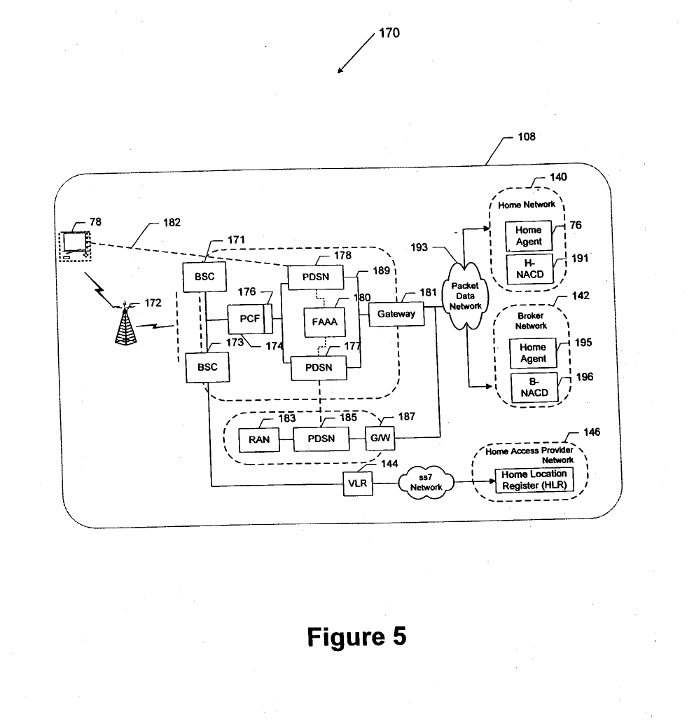

FIG. 5 is a block diagram illustrating an exemplary portion 170 of the 3G network 108, which provides support for communication between wireless mobile node 78 and the 3G network 108. The portion 170 includes a wireless mobile node 78, a base station (“BTS”) 172, base station controllers (“BSC”) 171 and 173, a PCF 174, a radio packet interface (“RPI”, which can also be realized using the IS-2001 A10/A11 interface) 176, source PSDNs 177 and 178, a FAAA server 180, a source gateway 181, a radio access network (“RAN”) 183, foreign PDSN 185, a foreign gateway 187, a Home Network 140, a Broker Network 142, a Visitor Location Register (VLR) 144, and a Home-Access-Provider Network 146.

Although FIG. 5 shows only two BSCs, i.e., BSCs 171 and 173, the portion 170 of the 3G system typically includes a large number of BSCs. Further, although FIG. 5 shows only a single BTS, i.e., BTS 172, coupled to BSC 173, each BSC may be connected to a greater or a fewer number of BTSs. Moreover, although FIG. 5 shows only three PDSNs, i.e., PDSN 177, PDSN 178 and PDSN 185, more, or less PDSNs may be included in portion 170.

The wireless mobile node 78 is communicatively coupled with the BTS 172 over an air interface. Communications transmitted across the air interface conform to the air interface protocol of the wireless communication format. For instance, in a CDMA circuit voice system, the protocol may be enhanced variable rate vocoder (EVRC) or IS-127. The BTS 172 in turn may be communicatively coupled to the BSC 173 and/or BSC 171. Communications transmitted across the interface connecting the BTS 172 and BSC 173 or BSC 171 may be transmitted according a protocol such as IS-707 or IS-127. Other protocols are possible as well.

BSC 171 and 173 are in communication with the VLR 144, and the Home-Access-Provider Network 146 via SS7 system. BSCs 171 and 173 are also in communication with PCF 174. Communications transmitted between BSCs 171 and 173 may be transmitted according to a protocol such as the IS-2001 A3/A7 interface or other wireless communication format. PCF 174 is also in communication with PDSN 177 and PDSN 178. The RPI 176, which is used for packet data signaling, provides a link between PCF 174 and PDSNs 177 and 178.

The RPI 176 defines two logical channels: an A10 channel for data and an A11 channel for signaling. A11 signaling may be based on Mobile IP messages including Registration Request (“RRQ”) and Registration Reply (“RRP”), Registration Update (“RUP”) and Registration Acknowledge (“RACK”). Data from the wireless mobile node 78 may be encapsulated in GRE packets and tunneled from the PCF 174 to the PDSN 178 over an A10 channel, where it is un-encapsulated and processed further.

The PDSN 178 is in communication with the source gateway 181 via a Pi interface 189. Similarly, PDSN 177 is in communication with the source gateway 181 via the Pi interface 189. Communications transmitted over the Pi interface 189 may be transmitted according to Mobile IP. Data sent over the Pi interface 189 may be transmitted as UDP over Mobile IP; however, other transmission protocols may be used. The source gateway 181 is in communication with the packet data network (PDN) 193. Communications transmitted between the source gateway 181 and PDN 193 may be exchanged using IP 48.

PDSN 178 and PDSN 177 are in communication with the FAAA server 180. The FAAA server 180 may maintain wireless mobile node 78 packet-data-provisioning information. This packet-data provisioning information may be stored in a user profile record (hereinafter referred to as “user profile”) in a data store that is accessible to the FAAA server 180. Further, the FAAA server 180 may be used to authenticate and determine the parameters of a wireless mobile node's 78 packet-data session.

The wireless mobile node 78 may establish a PPP 45 data link 182 that terminates at the PDSN 178 as is explained below. The PPP 45 data link 182 helps provide a “keep-alive” point-to-point-data link for higher-level application services 62 such as VoIP, and/or H.323.

Packet Data Network (“PDN”) 193 is in communication with the home network 140. Similar to the Pi interface 189, communications transmitted between the PDN 193 and the home network 140 may be transmitted according to IP. Communications over this link may be transmitted according to other transmission protocols as well.

The home network 140 may contain HA 76, and a home network-access-control device (H-NACD) 191. The H-NACD 191 may comprise one or more network-access servers that communicate according to the RADIUS protocol or the DIAMETER protocol. The H-NACD 191, however, may use other protocols. The mobile node may communication with more than one of the one or more network-access-control devices during the same logical session. The H-NACD 191 may have access to and/or maintain wireless mobile node 78 packet-data-provisioning information from the user profile. Similar to the FAAA server 180, the H-NACD 191 may be used to authenticate and de-terminate the parameters of a wireless mobile node's 78 packet-data session.

Broker network 142 is also in communication with the PDN 193. Communications transmitted between the PDN 193 and broker network 142 may be transmitted according to IP. Communications over this link may be transmitted according to other transmission protocols as well.

Broker network 142 may contain a broker network-access-control device (B-NACD) 196. The B-NACD 196 may comprise one or more network access servers that communicate according to the RADIUS protocol or the DIAMETER protocol. The B-NACD 196, however, may use other protocols. The B-NACD 196 may have access to and/or maintain wireless mobile node 78 packet-data-provisioning information from the user profile. Similar to the H-NACD 191, the B-NACD 196 may be used to authenticate and de-terminate the parameters of a wireless mobile node's 78 packet-data session.

PDSN 177 (and PDSN 178) is in communication with PDSN 185. Communications passed between PDSN 177 and PDSN 185 may be sent according to a PDSN-to-PDSN (P-P) protocol, such as TIA/EIA IS-835. More particularly, communications may be sent as UDP over P-P. Communications over this link may be transmitted according to other transmission protocols as well.

2. Support for Prepaid Billing for Wireless Mobile Nodes on a Data Network

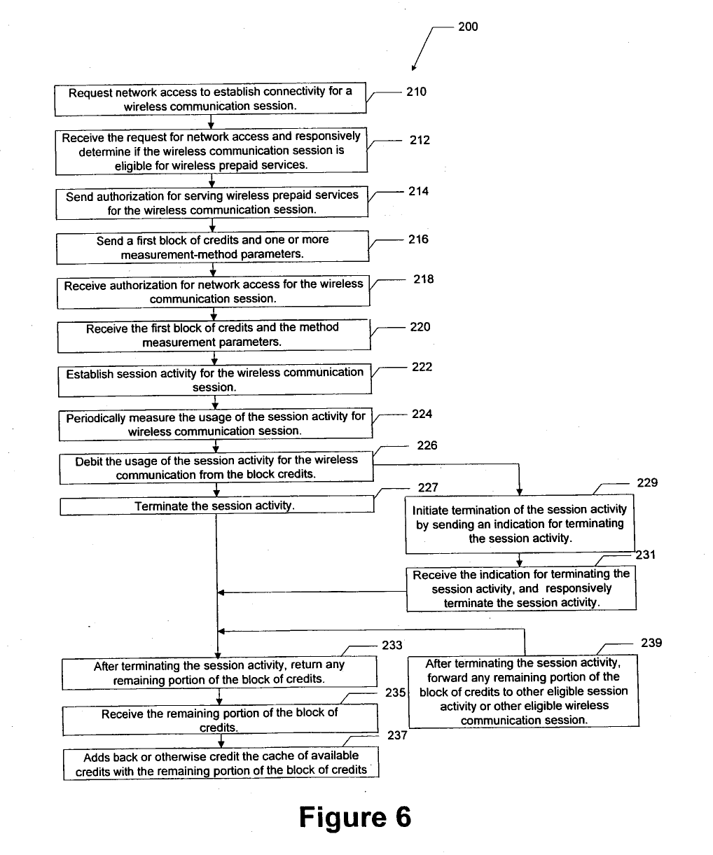

FIG. 6 is a flow diagram illustrating a method 200 for providing prepaid billing on a data network for wireless prepaid services in accordance with an exemplary embodiment. In FIG. 6, at step 210, a network-access device, such as a PDSN, requests network access from a network-access-control device, such as a AAA server, to establish connectivity for a wireless communication session for at least one wireless mobile node. At step 212, the network-access-control device receives the request for network access from the network-access device, and in response, determines if the wireless communication session is eligible for wireless prepaid services.

If eligible, at step 214, the network-access-control device sends to the network-access device authorization or other approval for serving wireless prepaid services to the wireless mobile device for the wireless communication session. In addition, at step 216, the network-access-control device sends to the network-access device a first block of credits and one or more measurement-method parameters. Alternatively, the network-access device may contain its own predetermined-measurement-method parameters. In such case, the network-access control device might not send the measurement-method parameters. However, despite having the predetermined-measurement-method parameters, the network-access-control may still send the measurement-method parameters to the network-access device. Doing so, leaves open the option of changing the measurement methods for determining usage of a prepaid wireless communication session.

The size of the first block of credits and any other block of credits sent to the network-access device may vary. For example, the block of credits may contain fractional credits, whole credits, or some combination of the factional and whole credits. Moreover, the number of credits may vary from block to block. In one instance, the network-access-control device may send to the network-access device (as the first block of credits) a block of credits containing a plurality of whole credits. In another instance, the network-access-control device may send to the network-access device (as the first block of credits) a block of credits containing only a fraction of a credit.

The network-access-control device may vary the size of the blocks of credits based on a supply of available credits contained in a cache of available credits. Alternatively, the network-access-control device may vary the size of the blocks of credits based on the type of session activity for the wireless communication session. For example, voice content may use one block size, while non-voice data may use another block size. Other conditions may cause the network-access-control device to vary the size of the blocks of credits as well.

At step 218, the network-access device receives the authorization or other approval for network access for the wireless communication session. And in addition to receiving the authorization or other approval, at step 220, the network-access device receives from the network-access-control device the first block of credits and, if sent, the measurement-method parameters.

Measurement-method parameters received in conjunction with a block of credits, such as those received with the first block of credits that only apply to that block of credits may be referred to as local-measurement-method parameters. The measurement-method parameters, however, may be “global” measurement-method parameters. As global-measurement-method parameters, the parameters may apply to the block they were received with, as well as with other blocks.

After receiving authorization for the wireless communication session, the network-access device, at step 222, establishes session activity for the wireless communication session. In an exemplary embodiment, the network-access device is in the path of the wireless communication session. Being in the path of the wireless communication session allows the network access device to directly monitor the usage of the wireless prepaid service used by the wireless communication session. The network-access device, however, need not be in the path of the wireless communication session. In such case, the network-access device indirectly monitors the usage of the wireless communication session. For example, the network-access device may receive the usage of the wireless communication session from a second-network-access device (e.g., another PDSN) that is in communication with the network-access device.

At step 224, the network-access device periodically measures the usage of the session activity for the wireless communication session. At step 226, the network-access device debits the usage of the session activity for the wireless communication from the block of credits received from the network-access-control device in step 216.

As illustrated in step 227, at any point or any time during the wireless communication session, the network-access device may terminate the session activity. Alternatively, at step 229, the network-access-control device may initiate termination of the session activity by sending to the network-access device an indication for terminating the session activity of the wireless communication session. In response to receiving from the network-access-control device the indication for terminating the session activity, the network-access device, at step 231, terminates the session activity of the wireless communication session. In either step 227 or step 231, after terminating the session activity of the wireless communication, the network-access device, at step 233, may send to the network-access-control device any remaining portion (i.e., any unused credits) of the block of credits.

At step 235, the network-access-control device receives the remaining portion of the block of credits. The network-access-control device, at step 237, “adds back” or otherwise credits the cache of available credits with the unused credits, if any. In an alternative embodiment, after terminating the session activity, the network-access device may forward to a second-network-access device any remaining portion of the block of credits for use with other eligible session activity or other eligible wireless communication sessions.

The foregoing steps illustrate method 200 with an exemplary embodiment. The method 200, however, is not limited to these steps. Other embodiments with other steps can be used to practice method 200, as well.

Further, the foregoing description indicates carrying out method 200 for one wireless communications session. The method 200, however, may be carried out for multiple, simultaneous wireless communications sessions. Since each wireless communication session is considered a separate communication session, method 200 may be carried out for each wireless communication session in the identical or similar manner as described above, but method 200 may be carried out in other ways as well. The multiple simultaneous wireless communication sessions may (i) originate and terminate from the one or more wireless mobile nodes, (ii) connect through the one or more network-access devices, (iii) tunnel from one network-access device to other network-access devices, (iv) be handed-off (e.g., soft, fast, and/or hard hand-off) from one network-access device other access devices, and/or (v) be eligible to receive prepaid wireless services from the same user profile.

Moreover, it is contemplated that during multiple, simultaneous wireless communication sessions, the network-access-control device may initiate a request to terminate one or more wireless communication sessions so that the portions of the block of credits allotted to such wireless communication sessions may be used by another communication session. The network-access-control device may initiate the request to terminate based on prepaid plan policies, such as communication session importance, or may initiate the request to terminate in response to a user request.

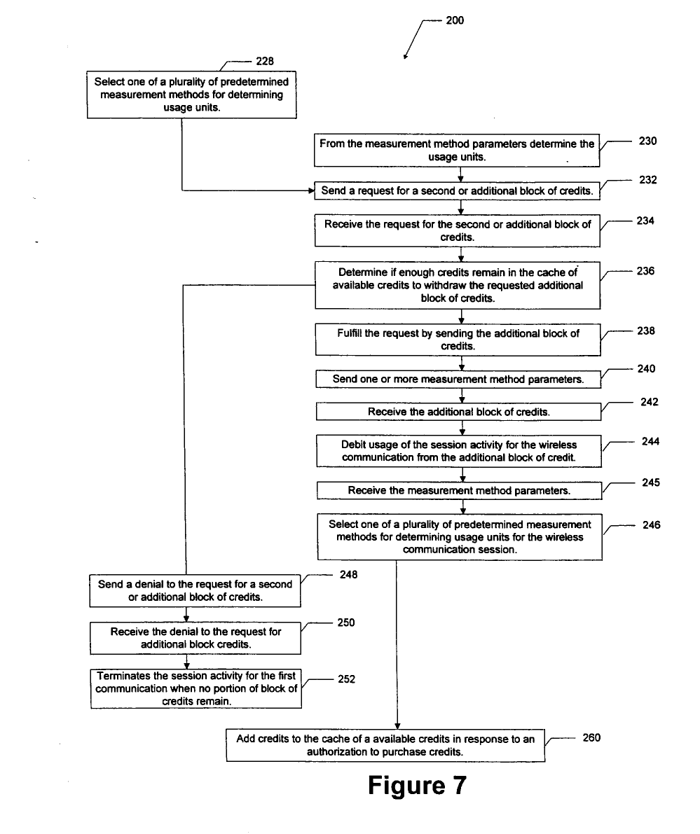

FIG. 7 is a flow diagram illustrating the method 200 for providing prepaid billing on a data network for wireless prepaid services in accordance with another exemplary embodiment. In addition to the steps illustrated in FIG. 6, FIG. 7 illustrates other steps for carrying out method 200.

Referring to FIG. 7, at step 228, in response to receiving one or more measurement-method parameters from the network-access-control device, the network-access device selects one of a plurality of its predetermined-measurement methods for determining usage units for the wireless communication session. The measurement-method parameters passed to the network-access device from the networks-access control device may include an indication for determining which of the plurality of predetermined-measurement methods the network-access device should select for determining the usage units for the wireless communication session. For instance, the measurement-method parameters may include one or more bits, bytes, pointers, algorithms, instructions, and/or other indicators that the network-access device may use for selecting one of the plurality predetermined-measurement methods. Each of the plurality of predetermined-measurement methods may include methods for measuring the session activity of the wireless communication session in terms of time used, time connected, bytes received, bytes transmitted, packets received, packets transmitted, and/or any other measurement method for wireless communication services.

Alternatively, at step 230, the measurement-method parameters passed to the network-access device from the network-access-control device may include an algorithm, conversion factor, and/or other instruction for determining the usage units for the wireless communication session. Similar to the plurality of predetermined-measurement methods contained within network-access device, these measurement-method parameters may provide the network-access device with one or more methods for measuring the session activity of the wireless communication session. These methods for measuring the session activity may be in terms of the time used, the time connected, the number of bytes received, the number of bytes transmitted, the number of packets received, the number of packets transmitted, and/or any other measurement method for wireless communication services.

For example, the network-access device may receive from the network-access-control device as one of the measurement-method parameters an algorithm that applies different usage units to the session activity of the wireless communication session depending on the type of data being passed. By processing the algorithm, the network-access device may use a first type of usage units for a first type of data, a second type of usage unit for a second type of data, and n^{th} type usage unit for an n^{th} type of data (where n is any integer) for the data being passed in the wireless communication session.

At step 232, the network-access device sends to the network-access-control device a request for a second or additional block of credits. The network-access device may make the request when a predetermined number of the credits remain in the block of credits. For instance, the network-access device may make the request for additional credits proactively. That is, the network-access device may make the request at any time before depletion of the block of credits. Alternatively, the network-access device may make the request for additional credits when the no credits remain in the block. In another alternative, the network-access device may make the request for additional credits based on an algorithm that insures that as long as available credits remain, the network-access device will receive additional blocks of credits. Other algorithms are possible as well.

The network-access-control device, at step 234, receives from the network-access device the request for the second or additional block of credits. At step 236, the network-access-control device determines if enough credits remain in the cache of available credits to withdraw the requested additional block of credits. If available credits remain, at step 238, the network-access-control device fulfills the request by sending to the network-access device the additional block of credits.

At step 240, the network-access-control device may also send to the network-access device one or more measurement-method parameters. These measurement-method parameters may vary from the measurement-method parameters sent to the network-access device in conjunction with the first block of credits. In an exemplary embodiment, the measurement-method parameters are local-measurement-method parameters. Alternatively, the measurement-method parameters sent to the network-access device at step 240 may be global-measurement-method parameters.

Step 240 may be omitted if, for example, the network-access-control device sent to the network-access device global-measurement-method parameters in conjunction with the sending the first block of credits, and the measurement-method parameters for the additional block of credits are also global-measurement-method parameters. In yet another alternative, step 240 may be omitted if, for example, the network-access-device contains a plurality of its predetermined-measurement methods and the network-access device has already selected one of a plurality of its predetermined-measurement methods for determining usage units for the wireless communication session. Step 240 may be omitted for various other reasons as well.

At step 242, the network-access device receives from the network-access-control device the additional block of credits. At block 244, the network-access device debits the usage of the session activity for the wireless communication session from the additional block of credits and the first block of credits, if any remain. In an exemplary embodiment, the network-access device is in the path of the wireless communication session. Because the network-access device may be in the path of the wireless communication session, it may directly measure the usage of the wireless prepaid service used by the wireless communication session. On the other hand, if the network-access device is not in the path of the wireless communication session, the network-access device may receive the usage of the wireless communication session from another network device.

Also illustrated in FIG. 7, at step 245, the network-access device may receive from the network-access-control device the measurement-method parameters. As noted above, the measurement-method parameters may be either local-measurement-method parameters or global-measurement-method parameters. Depending on the type of measurement-method parameters received, the method by which the network-access device determines the usage units for the session activity may vary.

In the local-measurement-method parameter case, the measurement-method parameters may differ from the measurement-method parameters received by the network-access device in conjunction with receiving the first block of credits. The differences between the measurement-method parameters received in step 230 and those received in step 245 may include different algorithms, conversion factors, and/or other instructions for determining the usage units for the wireless communication session.

The measurement-method parameters, however, may include one or more identical or similar algorithms, conversion factors, and/or other instructions for determining the usage units for the wireless communication session. These measurement-method parameters may provide methods for measuring the session activity of the wireless communication session in terms of the time used, the time connected, the number of bytes received, the number of bytes transmitted, the number of packets received, the number of packets transmitted, and/or any other measurement method for wireless communication services.

At block 246, in response to receiving one or more measurement-method parameters, the network-access device may select one of a plurality of its predetermined-measurement methods for determining usage units for the wireless communication session. Paralleling step 230, the measurement-method parameters passed to the network-access device from the networks-access control device may include an indication for determining which of the plurality of predetermined-measurement methods that the network-access device should select for determining the usage units for the wireless communication session. These indications may include one or more bits, bytes, pointers, algorithms, instructions, and/or other indicators that the network-access device may use in selecting a particular (e.g., the first) predetermined-measurement methods.

The global-measurement-method parameter case is similar to the local-measurement-method parameter case, except that the measurement-method parameters passed to the network-access device from the network-access-control device in conjunction with the additional block of credits do not differ from those passed in conjunction with the first block of credits. Step 246 might be omitted if the measurement-method parameters are global-measurement-method parameters.

At step 248, in response to the network-access-control device receiving from the network-access device the request for the second or additional block of credits, the network-access-control device may send to the network-access device a denial to the request for a second or additional block of credits. The network-access-control device may send this denial for a variety of reasons. For instance, a denial to the request may be sent because (i) no available credits may remain, (ii) the available credits are reserved for another wireless communication session, (iii) the request for an additional block of credits for the wireless communication session exceeds a maximum value, and/or (iv) other restrictions are placed upon allocating credits for the wireless communication session.

At step 250, the network-access device receives from the network-access-control device the denial to the request for an additional block credits. Responsively the network-access device, at step 252, terminates the session activity for the first communication when no portion of block of credits remains.

At step 260, credits may be added to the cache of available credits in various ways. As will be described in more detail below, the credits may be added to the cache of available credits in response to an authorization to purchase credits.

The foregoing steps illustrate method 200 with an exemplary embodiment. The method 200, however, is not limited to these steps. Other embodiments with other steps can be used to practice method 200, as well. Further, the foregoing description indicates carrying out method 200 for one wireless communication session. The method 200, however, may be carried out for multiple, simultaneous wireless communications sessions as well. Since each wireless communication session is considered a separate communication session, method 200 may be carried out for each wireless communication session in the identical or similar manner as described above, but method 200 may be carried out in other ways as well.

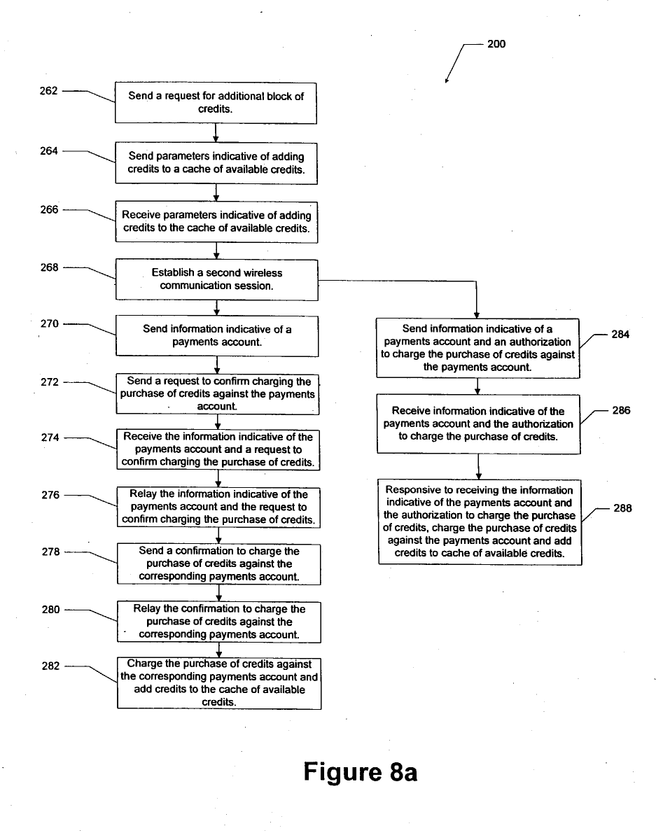

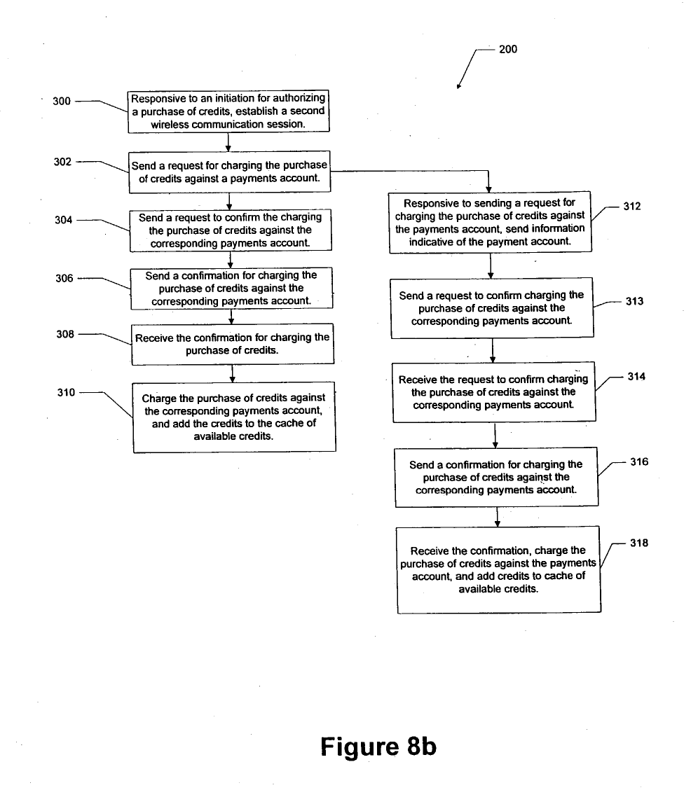

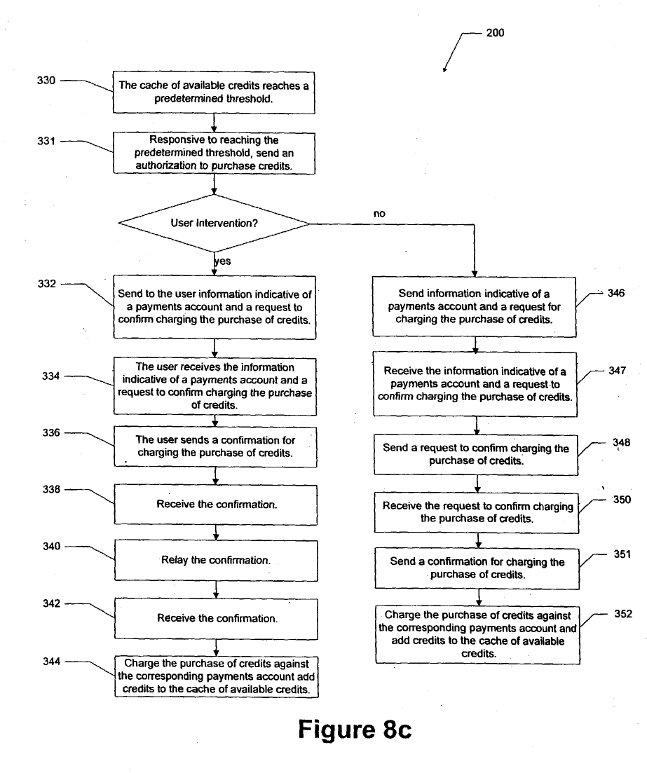

FIGS. 8a, 8b, and 8c are flow diagrams illustrating the method 200 for providing prepaid billing on a data network for wireless prepaid services in accordance with another exemplary embodiment. FIGS. 8a, 8b, and 8c illustrate exemplary steps for carrying out the function of adding credits to the cache of available credits in accordance with method 200.

Referring to FIG. 8a, at step 262, the network-access device sends to the network-access-control device a request for a second block of credits. The network-access-control device, at step 264, sends to the network-access device parameters indicative of adding credits to the cache of available credits. These parameters may include (i) a denial to the request for a second or additional block of credits, (ii) an indication (e.g., a URL or an IP address) of the second-access-control device, and/or (iii) any other notation that indicates that no available credits remain. The parameters are used as a trigger for establishing a second wireless communication between the wireless mobile node that is engaged in the wireless communication session and the second-network-access-control device. These parameters may also prompt the network-access device to redirect the wireless communication session to a redirect-network device for “keeping alive” the wireless communication session. The network-access device may implement this redirect as a packet filter that only allows the mobile node to communication with certain protocols (e.g., a web or HTTP compliant protocol) to certain network devices (e.g., the redirect server). The duration of this redirection may last until credits are purchased, whereby, after the purchase, the wireless communication session continues as before; or alternatively, until the second-communication session is otherwise terminated, whereby the wireless communication session may continue until no credits remain.

At step 266, the network-access device receives from the network-access-control device the parameters indicative of adding credits to the cache of available credits. In response, at step 268, the network-access device establishes the second wireless communication session. After establishing the second wireless communication session, the second-network-access-control device sends to the network-access device information indicative of a payments account at block 270.

The payments account is a monetary-based account or plurality of accounts for purchasing credits that will be added to the cache of available credits. The types of payments account may include a (i) credit account, such as a revolving credit arrangement or agreement; (ii) a debit account, such as a bank card that debits money from a bank account; (iii) a deposit account, such as a checking account, and/or (iii) any other debitable monetary account.

Information about the payments account may be stored and maintained in the user profile that may be accessible to (i) the network-access-control device, (ii) the second-network-access-control device, (iii) and/or other network device. For each of the monetary-based accounts in the payments account, the information about the payments account may include the payments account identification (e.g., credit card number); billing address; name of the user associated with the payments account; expiry information; trust information, such as security keys; and/or any other information for approving the purchase of credits.

At step 272, the second-network-access-control device may also send to the network-access device a request to confirm charging the purchase of credits against the payments account that corresponds with the information indicative of the payments account. At step 274, the network-access device receives from the second-network-access-control device the information indicative of the payments account and the request to confirm charging the purchase of credits against the corresponding payments account. At step 276, the network-access device relays to the wireless mobile node the information indicative of the payments account and the request to confirm charging the purchase of credits. If desired, at step 278, the wireless mobile node (or the user thereof) responsively sends to the network-access device a confirmation. This confirmation provides the authorization to purchase credits.

In turn, at step 280, the network-access device relays to the second-network-access-control device the confirmation. After receiving the confirmation, the second-network-access-control device charges the purchase of credits against the corresponding payments account and adds credits to the cache of available credits, as illustrated in step 282.

In an alternative embodiment, after the network-access device establishes the second wireless communication session, the wireless mobile node, at step 284, sends to the second-network-access control device information indicative of the payments account and an authorization to charge the purchase of credits against the corresponding payments account. At step 286, the second-network-access-control device receives from the wireless mobile node such information. In response, the second-network-access-control device charges the purchase of credits against the payments account and adds credits to the cache of available credits, as illustrated in step 288.

The foregoing steps illustrate one exemplary embodiment for adding credits to the cache of available credits in accordance with method 200. The method 200, however, is not limited to these steps. Other embodiments with other steps may be used to practice method 200. Further, the foregoing description indicates carrying out method 200 for one wireless communications session. The method 200, however, may be carried out for multiple, simultaneous wireless communications sessions as well. Since each wireless communication session is considered a separate communication session, method 200 may be carried out for each wireless communication session in the identical or similar manner as described above, but method 200 may be carried out in other ways as well.

Referring to FIG. 8b, another exemplary process for adding credits to the cache of available credits is shown. In response to a user initiation for authorizing a purchase of credits, the network-access device, at step 300, establishes a second wireless communication session between the wireless mobile node and the second-network-access-control device. At step 302, the wireless mobile node sends to the second-network-access-control device a request for charging the purchase of credits against a payments account.

The request for charging the purchase of the credits against a payments account may include information indicative of the payments account, and an authorization to charge the purchase of credits. Alternatively, the user may send to the second-network-access-control device (i) the request for charging the purchase of credits, (ii) the information indicative of the payments account, and (iii) the authorization to charge the purchase of credits against the payments account separately.

At step 304, the second-network-access control device may send to the wireless mobile node a request to confirm charging the purchase of credits against the corresponding payments account. Responsive to receiving the request, the wireless mobile node, at step 306, sends to the second-network-access-control device a confirmation for charging the purchase of credits against the corresponding payments account, thereby authorizing the purchase of credits. At step 308, the second-network-access device receives the confirmation. After receiving this confirmation, the second-network-access-control device charges the purchase of credits against the corresponding payments account, and adds credits to the cache of available credits, as illustrated in step 310.

In another alternative embodiment, at step 312, the second-network-access-control device may respond to the request for charging the purchase of credits by sending to the wireless mobile node information indicative of the payments account. Further, at step 313, the second-access-control device may send to the wireless mobile node a request to confirm charging the purchase of credits against the payments account that corresponds with the information indicative of the payments account. At step 314, the wireless mobile node receives the information indicative of the payments account and the request to confirm charging the purchase of credits against the corresponding payments account.

At step 316, the wireless mobile node responsively sends to the second-network-access-control device a confirmation for charging the purchase of credits against the corresponding payments account, thereby authorizing the purchase of credits. After receiving this confirmation, the second-network-access-control device charges the purchase of credits against the payments account, and adds credits to the cache of available credits, as illustrated in step 318.

The foregoing steps illustrate one exemplary embodiment for adding credits to the cache of available credits in accordance with method 200. The method 200, however, is not limited to these steps. Other embodiments with other steps can be used to practice method 200, as well. Further, the foregoing description indicates carrying out method 200 for one wireless communications session. The method 200, however, may be carried out for multiple simultaneous wireless communications sessions as well. Since each wireless communication session is considered a separate communication session, method 200 may be carried out for each wireless communication session in the identical or similar manner as described above, but also the method 200 may be carried out in other ways as well.

Referring to FIGS. 8c, another exemplary process for adding credits to the cache of available credits is shown. At step 330, the cache of available credits reaches a predetermined threshold. This threshold may be (i) a predetermined number of credits; (ii) a specific time, such as every month; (iii) and/or any other threshold. When the cache of available credits reaches the threshold, the network-access-control device sends to the second-network-access-control device an authorization to purchase credits at step 331. This authorization to purchase credits may or may not involve user intervention.

Whether or not the authorization to purchase credits involves user intervention, as noted above, information indicative of the payments account may be stored and maintained in the user profile that may be accessible to the network-access-control device. Alternatively, the information indicative of the payment account may be tunneled (for security reasons) to the network-access-control device from the second-network-access-control device, which also has access to the user profile.

If the authorization to purchase credits involves user intervention, then after obtaining the information indicative of the payments account, at step 332, the network-access-control device sends to the wireless mobile node (and the user thereof) the information indicative of the payments account and a request to confirm charging the purchase of credits against the corresponding payments account. At block 334, the wireless mobile node receives the information indicative of the payments account and the request to confirm charging the purchase of credits against the corresponding payments account. In response, the user via the wireless mobile node, at step 336, sends to the network-access-control device a confirmation for charging the purchase of credits against the corresponding payments account, thereby authorizing the purchase of credits.

The network-access-control device receives the confirmation for charging the purchase of credits against the corresponding payments account at step 338. Responsively, at step 340, the network-access-control device relays to the second-network-access-control device this confirmation. At step 342, the second-network-access-control device receives the confirmation. After receiving the confirmation, the second-network-access-control device charges the purchase of credits against the corresponding payments account and adds credits to the cache of available credits at step 344.

Authorization to purchase credits might not involve user intervention. For example, the user profile may contain an indication for automatically adding credits to the cache of available credits when the cache reaches the predetermined threshold. In such case, at step 346, the network-access-control device may send to the second-network-access-control device information indicative of the payments account and a request for charging the purchase of credits against the corresponding payments account.

At step 347, the second-network-access-control device receives the information indicative of the payments account and the request for charging the purchase of credits against the corresponding payments account. At step 348, the second-network-access-control device may send to the network-access-control device a request to confirm charging the purchase of credits against the corresponding payments account.

At step 350, the network-access-control device receives the request to confirm charging the purchase of credits against the corresponding payments account, and at step 351 responsively sends to the second-network-access-control device a confirmation for charging the purchase of the credits against the corresponding payments account. After receiving the confirmation, the second-network-access-control device charges the purchase of credits against the corresponding payments account, and adds credits to the cache of available credits at step 352.

In yet another alternative embodiment, steps 348, 350, and 351 may be omitted. Accordingly, after receiving the request for charging the purchase of credits against the corresponding payments account, the second-network-access-control device charges the purchase of credits against the corresponding payments account and adds credits to the cache of available credits.

The foregoing steps illustrate an exemplary embodiment for adding credits to the cache of available credits in accordance with method 200. The method 200, however, is not limited to these steps. Other embodiments with other steps can be used to practice method 200. Further, the foregoing description indicates carrying out method 200 for one wireless communications session. The method 200, however, may be carried out for multiple, simultaneous wireless communications sessions as well. Since each wireless communication session is considered a separate communication session, method 200 may be carried out for each wireless communication session in the identical or similar manner as described above, but also, the method 200 may be carried out in other ways as well.

In such other exemplary embodiment, account information for pre-paid mobile services purchased for a Mobile IP wireless mobile node 78 is stored in the user profile accessible by FAAA server 180, H-NACD 191, B-NACD 196, all of which are associated with a 3G network 108. No limitation to such an embodiment, however, is intended, and virtually any network access control device, such as network access server, on the 3G network 108 can be used.

In one embodiment, account information for pre-paid mobile services is based on individual or combinations of the measurement methods provided for the different type of services available. Some examples of measurement methods are listed in Table 1 below. However, more, fewer or other pre-paid mobile services can also be used.

TABLE 1

| | |
|---|---|
| Time: | Subscribers can purchase a specific amount of transmit |
| | and/or receive time during which they can use wireless |
| | data services. Note that since 3G services can be |
| | always on, time spent in active state may be counted |
| | towards usage as well as time spent in dormant state |
| | may be counted, depending on the plan purchased. |
| Bytes | Subscribers can purchase a package (as determined by |
| Received: | the carrier) that entitles them to access wireless |
| | data services and receive a specific number of |
| | data bytes received. |
| Bytes | Subscribers can purchase a package (as determined by the |
| Transmitted: | carrier) that entitles them to access wireless data services |
| | and transmit a specific number of data bytes transmitted. |
| Packets | Subscribers can purchase a package (as determined by the |
| Received: | carrier that entitles them to access wireless data services |
| | and receive a specific number of data packets received. |
| Packets | Subscribers can purchase a package (as determined by the |
| Transmitted: | carrier) that entitles them to access wireless data services |
| | and transmit a specific number of data packets transmitted. |

3. Support for Prepaid Billing for Wireless Mobile Nodes on a Third Generation Network

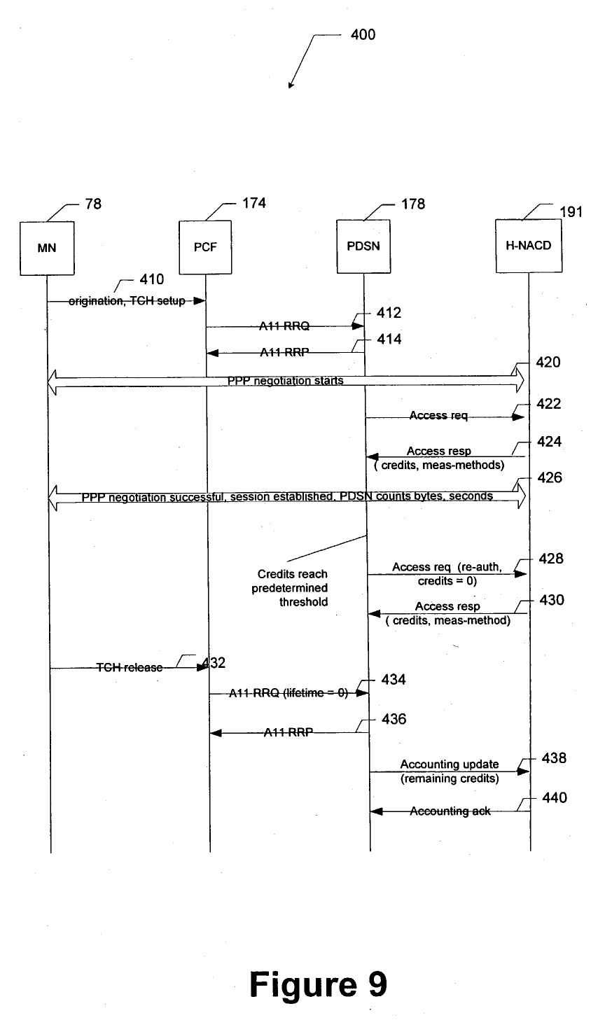

FIG. 9 is a call flow diagram illustrating an exemplary message flow 400 for setup, teardown, and maintenance of a wireless prepaid call on network portion 170 of 3G network 108 as illustrated in FIG. 5. Referring to FIG. 9, wireless mobile node 78 initiates a communication session by sending a Traffic CHannel (“TCH”) setup message 410 to the PCF 174. For purposes of this discussion the PCF 174 is intended to also refer to the base station and base station controller. The PCF 174 sends a Mobile IP registration request 412 to PDSN 178 on an A11 channel to request registration of the wireless mobile node 78 on network 108. The PDSN 178 responds with a successful Mobile IP registration response message 414 on an A11 channel.

In response, the wireless mobile node 78 begins PPP 45 negotiations 420 with the H-NACD 191 to establish a PPP 45 session 182. In an exemplary embodiment, the PDSN 178 sends a Mobile IP registration request message 422 for the PPP 45 session 182 over an A11 channel to the H-NACD 191. (Step 210 in FIG. 6) The H-NACD 191 responds with a Mobile IP registration reply message 424 that includes a first block of credits, and may include one or more measurement-method parameters. (Steps 212, 214, and 216 in FIG. 6)

At 426, the wireless mobile node 78 successfully negotiates PPP 45 with the H-NACD 191 and establishes the PPP 45 session 182 activity. (Step 222 in FIG. 6) After session activity is established, PDSN 178 monitors usage of the PPP 45 session 182 activity and periodically measures the usage of the PPP 45 session 182 activity in terms of the measurement-method parameters, such as those listed in table 1. (Step 224 in FIG. 6) The PDSN 178 then debits the measured usage from first block of credits. (Step 226 in FIG. 6) When the number of credits in the block of credits reaches a predetermined threshold, for example when the PDSN 178 runs out of credits, the PDSN 178 sends to the H-NACD 191 over a RADIUS access-request message 428 for re-authentication of the PPP 45 session 182. (Step 232 in FIG. 7) The H-NACD 191 responds with a RADIUS access-response message 430, and an additional block of credits. The H-NACD 191 may also send one or more measurement-method parameters. (Steps 238 and 240 in FIG. 7)

At any time, the wireless mobile node 78 may desire to terminate its PPP 45 session 182. To do so, wireless mobile node 78 send a Traffic CHannel (“TCH”) release message 432 to the PCF 174. The PCF 174 sends a Mobile IP registration request message 434 on an A11 channel to the PDSN 178 with a lifetime timer set equal to zero indicating that the wireless mobile node 78 should be de-registered. The PDSN 178 sends to the PCF 174 a Mobile IP registration response message 436 on an A11 channel confirming the de-registration of the mobile node 78.

Responsively, the PDSN 178 sends to the H-NACD 191 an accounting update message 438. (Step 233 in FIG. 6). The accounting update message 438 may contain the remaining unused portion of the block of credits for pre-paid mobile services for the mobile node 78. The H-NACD 191 re-stores the unused portion of pre-paid mobile services (i.e. unused credits) for the wireless mobile node 78, and sends to the PDSN 178 an accounting update acknowledgement message 440. (Steps 235 and 237 in FIG. 6).

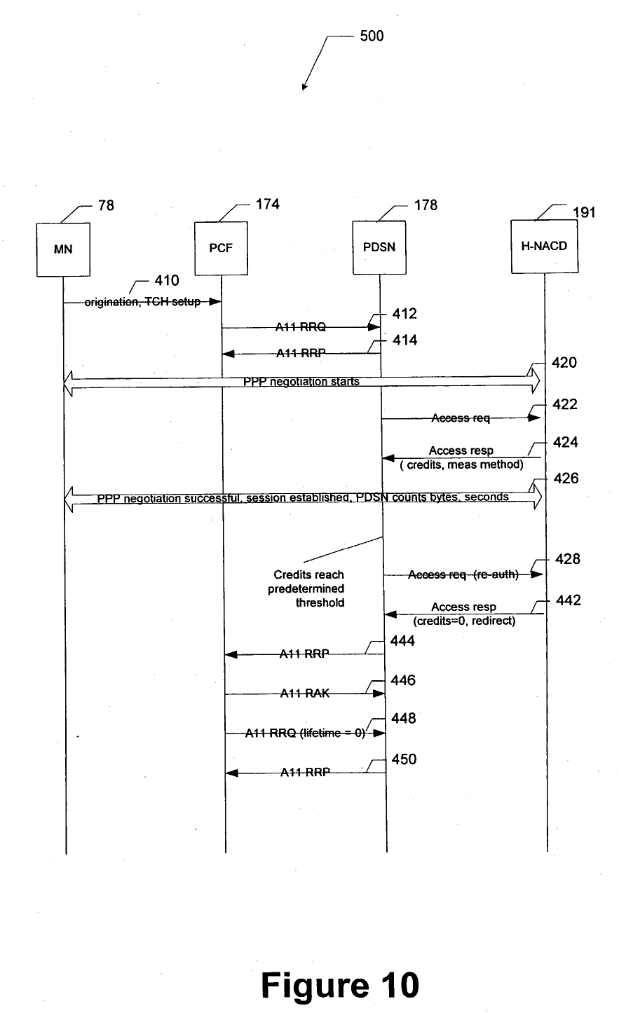

FIG. 10 is a call flow diagram illustrating an exemplary message flow 500 for setup, teardown, maintenance, and depletion of wireless prepaid services for a wireless prepaid call on network portion 170 of 3G network 108 as illustrated in FIG. 5. FIG. 10 shows the exemplary message flow 500, which is similar to the exemplary message flow 400, except as described herein.

When the number of credits in the block of credits reaches a predetermined threshold, for example, when the block of credits run out, the PDSN 178 sends to the H-NACD 191 over a RADIUS access-request message 428 for re-authentication of the PPP 45 session 182. (Step 232 in FIG. 7) The H-NACD 191 responds with a Mobile IP registration reply message 442, containing an indication, such as the URL or IP 48 address of a redirect server, for informing the PDSN 178 that credits need to be added to the cache of available credits. (Step 260 in FIG. 7, and step 266 in FIG. 8a)

When no available credits remain, the PDSN 178 sends to the PCF 174 on an A11 channel a Mobile IP registration update message 444. The PCF 174 responds to the request by sending to the PDSN 178 on an A11 channel a Mobile IP request acknowledgment message 446. The PCF 174 then sends a Mobile IP registration update message 448 on an A11 channel to the PDSN 178 with a lifetime timer set equal to zero indicating that the wireless mobile node 78 should be de-registered. The PDSN 178 sends to the PCF 174 a Mobile IP registration response message 450 on an A11 channel confirming the de-registration of the mobile node 78.

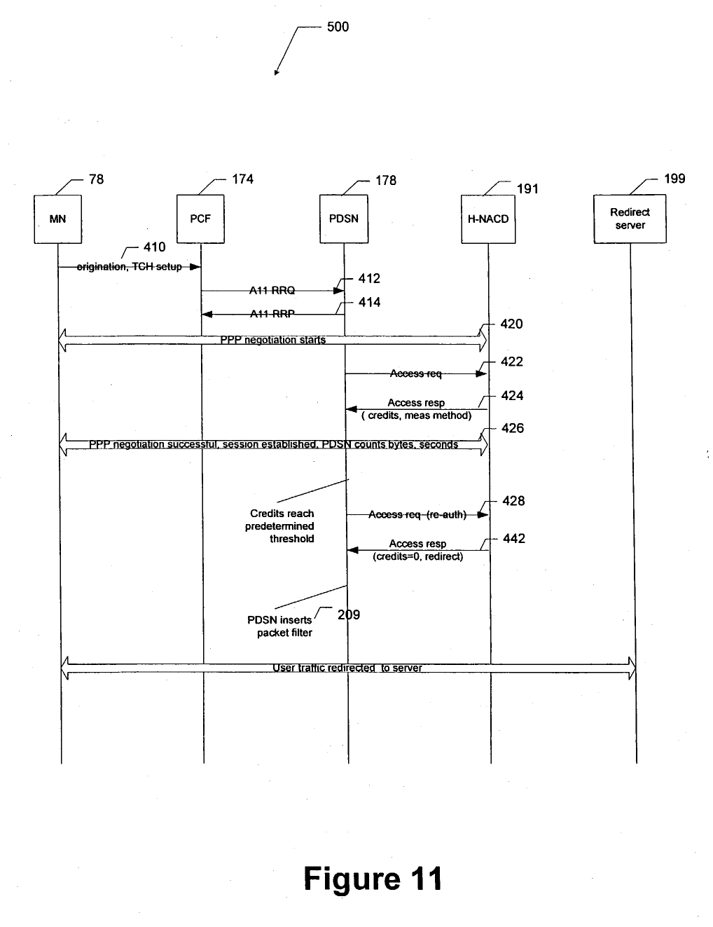

FIG. 11 is a call flow diagram illustrating an exemplary message flow for redirecting a wireless prepaid call on network portion 170 of 3G network 108 for purchasing credits for prepaid services in accordance with an exemplary embodiment. FIG. 11 shows the exemplary message flow, which is similar to the exemplary message flow 500, except as described herein. When the number of credits in the block of credits reaches a predetermined threshold, the PDSN 178 sends to the H-NACD 191 a RADIUS access-request message 428 for re-authentication of the PPP 45 session 182. (Step 232 in FIG. 7) The H-NACD 191 responds with a RADIUS access-response message 442, containing an indication, such as the URL or IP 48 address of the redirect server 199, for informing the PDSN 178 that credits need to be added to a cache of available credits. (Step 260 in FIG. 7, and step 266 in FIG. 8a)

Responding to the RADIUS access-response message 442, the PDSN 178 redirects the PPP 45 session 182 activity to the URL or IP 48 address of a redirect server 199. The redirect server 199 provides an interface that allows the user (via the wireless mobile node) to purchase more credits. In an exemplary embodiment, the purchase of credits takes place over a secured link, such as a Secure Socket Layer (“SSL”) link over the Internet or other packet-data network. The redirect server 199 may apply a packet filter 209 to the redirected PPP 45 session 182 activity for “keeping alive” the wireless communication session during the purchasing process.

The foregoing call flow diagrams illustrate exemplary embodiments for carrying out method 400 and method 500. These methods, however, are not limited to these embodiments, but rather, other embodiments with other steps can be used to practice method 200, as well. Further, the foregoing description indicates carrying out the methods for one wireless communications session. However, the methods may be carried out for multiple simultaneous wireless communications sessions as well. Since each wireless communication session is considered a separate communication session, the methods may be carried out for each wireless communication session in the identical or similar manner as described above, but method 200 may be carried out in other ways as well.

Various other implementations of method 200 are possible. In the foregoing description the network-access-control device, the H-NACD 191, and the B-NACD 196 may communicate according to the client/server based RADIUS protocol and/or the peer-to peer DIAMETER protocol.

As noted above, the RADIUS AAA protocol may be used for providing authentication, association, and accounting functionality to wireless packet data networks. Servers that employ the RADIUS AAA protocol are based on client/server architecture. Consequently, this type of server waits until a client sends it a request before being able to notify the client of events. In other words, a RADIUS AAA server cannot notify the client of events asynchronously. The DIAMETER protocol enhances many of the features of the RADIUS protocol. One important enhancement is that the DIAMETER protocol supports peer-to-peer architecture. This type of architecture allows one network device to asynchronously notify another network device and initiate an inter-peer communication at any point in time.

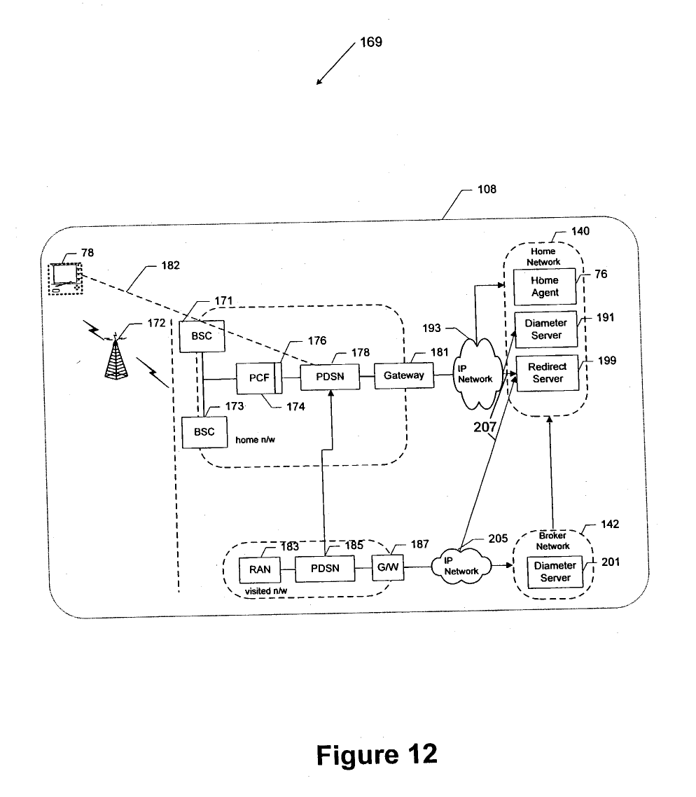

FIG. 12 is a block diagram illustrating an exemplary portion 169 of the 3G network 108 using the DIAMETER protocol for AAA services. FIG. 12 shows exemplary portion 169, which is similar to exemplary portion 170, except as described herein.

Paralleling portion 170 (FIG. 5), the portion 169 includes a wireless mobile node 78, a base station (“BTS”) 172, base station controllers (“BSC”) 171 and 173, a PCF 174, a radio packet interface (“RPI”) 176, a source PSDN 178, a source gateway 181, a radio access network (“RAN”) 183, a foreign PDSN 185, a foreign gateway 187, a home network 140, a HA 76, a broker network 142, and PDN 193.

Portion 169 includes both a home AAA server (HAAA) 191 and a broker AAA server (BAAA) 201, which are configured to carry out communications according to the DIAMETER protocol. Further included in portion 169 are Redirect Server 199, and a second packet data network (S-PDN) 205. The S-PDN 205, like PDN 193, may be the Internet, and/or a public or private intranet/extranet. Thus, the S-PDN 205 may be, but need not be, the same network as PDN 193.

As described above, HA 76 is in communication with PDN 193. Between these network nodes, communication may be transmitted according to the Mobile IP, or any other packet data transmission protocol. HAAA 191 is also in communication with the PDN 193. Communications exchanged between the PDN 193 and the HAAA 191 are sent according to the DIAMETER protocol. Similarly, broker network 142 is in communication with the S-PDN 205 and home network 140. Over these connections, the communications may be likewise transmitted according to the DIAMETER protocol.

Redirect server 199 is in communication with both PDN 193 and second packet data network 205. The redirect server 199 may use IP 48 or other data protocols for communication.

In another exemplary embodiment, wireless mobile node 78 is in communication with RAN 183. In turn, the RAN 183 is in communication with PDSN 185. PDSN 185 is in communication with the BAAA 201, which in turn is in communication with a HAAA 191. Alternatively, the PDSN 185 may communicate directly with the HAAA 191.

The following example call flow diagrams illustrate implementations of method 200 using the exemplary architecture shown in FIG. 12.

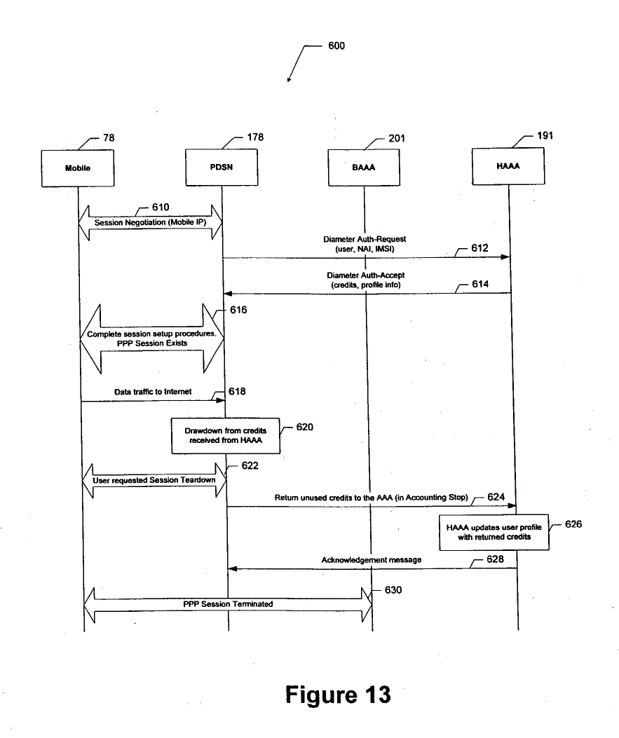

FIG. 13 is a call flow diagram illustrating an exemplary message flow 600 for setting up, tearing down, and maintaining a wireless prepaid call on a 3G network using the DIAMETER protocol in accordance with an exemplary embodiment. Referring to FIG. 13, wireless mobile node 78 begins PPP 45 negotiations 610 with the PDSN 178 to establish a PPP 45 session 182. In an exemplary embodiment, the PDSN 178 sends to the HAAA 191 a DIAMETER Auth-Request message 612 for the PPP 45 session 182.

The Auth-Request message 612 sent from the PDSN 178 the HAAA 191 is used for authenticating and authorizing the PPP 45 session 182, and may use the Challenge Handshake Authentication Protocol (CHAP) or the Password Authentication Protocol (PAP) for security purposes. If the Auth-Request message 612 is sent to the BAAA 201, it, in turn, may forward the Auth-Request request 612 to the HAAA 191. The Auth-Request message 612 may contain information to identify the user that is requesting service.

The HAAA 191 queries the user profile (either locally or in a remote data store), and sends to the PDSN 178 an Auth-Accept message 614, which may contain a first block of credits, and may include one or more measurement-method parameters or credit rating information. The measurement-method parameters in the Auth-Accept message 614 may contain user profile information including usage units for subscribed services. For instance, the Auth-Accept message 614 may contain DIAMETER attribute value pairs (AVPs) for (i) indicating that the usage should be applied on some number of bytes of use, (ii) notifying the user (via the wireless mobile 78) of the number of bytes of credit that are available, (iii) notifying the user (via the wireless mobile node 78) of the number bytes that remain, (iv) indicating that the user should be sent to Redirect server 199, and/or (v) notifying the user (via the wireless mobile node 78) that usage updates may be sent at some selected frequency.

The wireless mobile node 78 successfully negotiates 616 PPP 45 with the HAAA 191 and establishes the PPP 45 session 182 activity. Data 618 may be sent via the Internet and/or any other packet data network. After session activity is established, PDSN 178, at 620, monitors usage of the PPP 45 session 182 activity and periodically measures the usage of the PPP 45 session 182 activity in terms of the measurement-method parameters, such as those listed in table 1. Also at 620, the PDSN 178 debits the measured usage from the first block of credits.

At 622, the wireless mobile node 78 initiates teardown of its PPP 45 session 182 according to Mobile IP. In response, PDSN 178 sends to the HAAA 191 a DIAMETER Accounting-Stop message 624. The Accounting-Stop message 624 may contain any remaining portion (i.e., unused portion) of the block of credits. At 626, the HAAA 191 updates the cache of available credits with the unused credits. HAAA 191 then sends to the PDSN 178 a DIAMETER Accounting acknowledgement message 628. At 630, the PDSN 178 and wireless mobile node 78 then terminate the PPP 45 session 182.

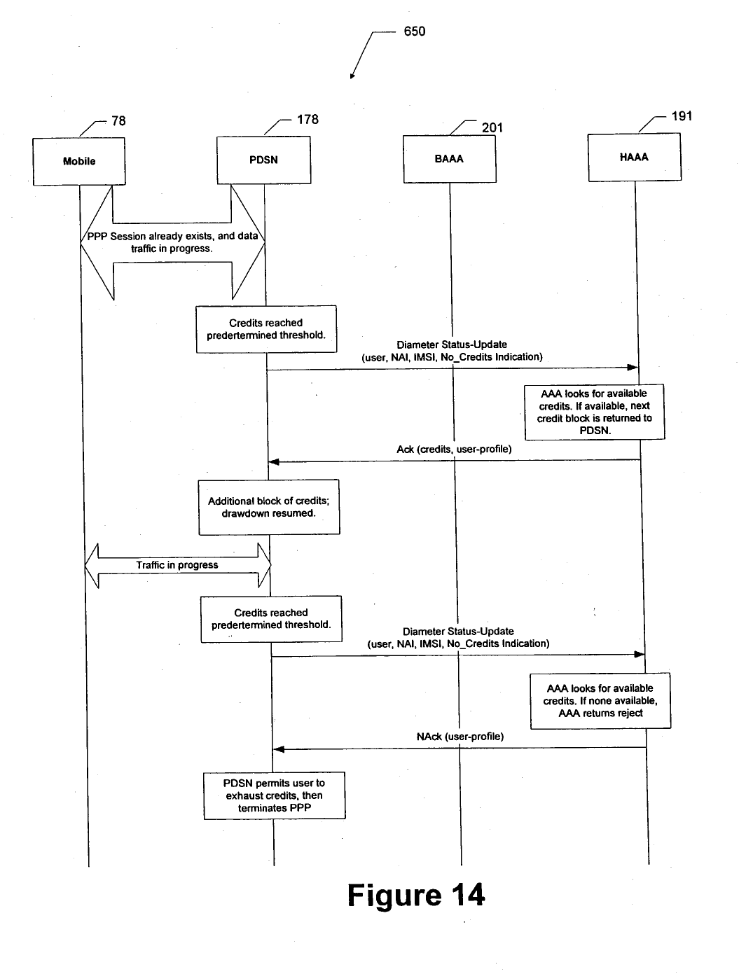

FIG. 14 is a call flow diagram illustrating an exemplary message flow 650 for setting up, tearing down, and maintaining a wireless prepaid call on network portion 169 of 3G network 108 using the DIAMETER protocol for purchasing credits for prepaid services in accordance with an exemplary embodiment. FIG. 14 shows the exemplary message flow 650, which one skilled in the art will recognize as being similar to the exemplary message flow 500, except that the message flow 650 illustrates AAA messaging between the PDSN 178 and the HAAA 191 according to the DIAMETER protocol.

At step 652, a PPP 45 session between the mobile node 78 and PDSN 178 is active and data transfer may be in progress. At step 654, the PDSN 178 determines that the credits allocated to the mobile node 78 have reached the predetermined threshold. Responsively, the PDSN 178 sends a DIAMETER status-update message 656 to the HAAA 191. The DIAMETER status-update message 656 may include a user name or user ID in the form of a Network Access Identifier (“NAI”), an International Mobile Station Identification (“IMSI”) number, and/or an indication that there are no credits or low credits remaining for the mobile node 78. At step 658, the HAAA 191 responsively determines if more credits are available for the mobile node 78. If there are more credits available, these credits may be returned to the PDSN 178 in a DIAMETER Ack message 660, along with an optional user profile. At step 662, the PDSN receives the DIAMETER Ack message 660 and adds the newly granted credits to any existing credits still at PDSN 178, and continues the drawdown of the credits as per described earlier.

At step 664, some time has gone by but the traffic between the mobile node 78 and the PDSN 178 is still in progress. At step 666, the PDSN 178 determines that the credits allocated to the mobile node 78 have reached the predetermined threshold. Responsively, the PDSN 178 sends a DIAMETER status-update message 668 to the HAAA 191. The DIAMETER status-update message 668 may include a user name or user ID in the form of an NAI, an IMSI number, and/or an indication that there are no credits or low credits remaining for the mobile node 78. At step 670, the HAAA 191 determines that there are no more credits available for the mobile node 78. Responsively, at step 672, the HAAA 191 sends the PDSN 178 a DIAMETER NAck message indicating that no more credits have been granted. At step 674, the PDSN 178 allows the mobile node 78 to continue to use any remaining credits until the credits are exhausted, then the PDSN 178 terminates the PPP 45 session with the mobile node 78.

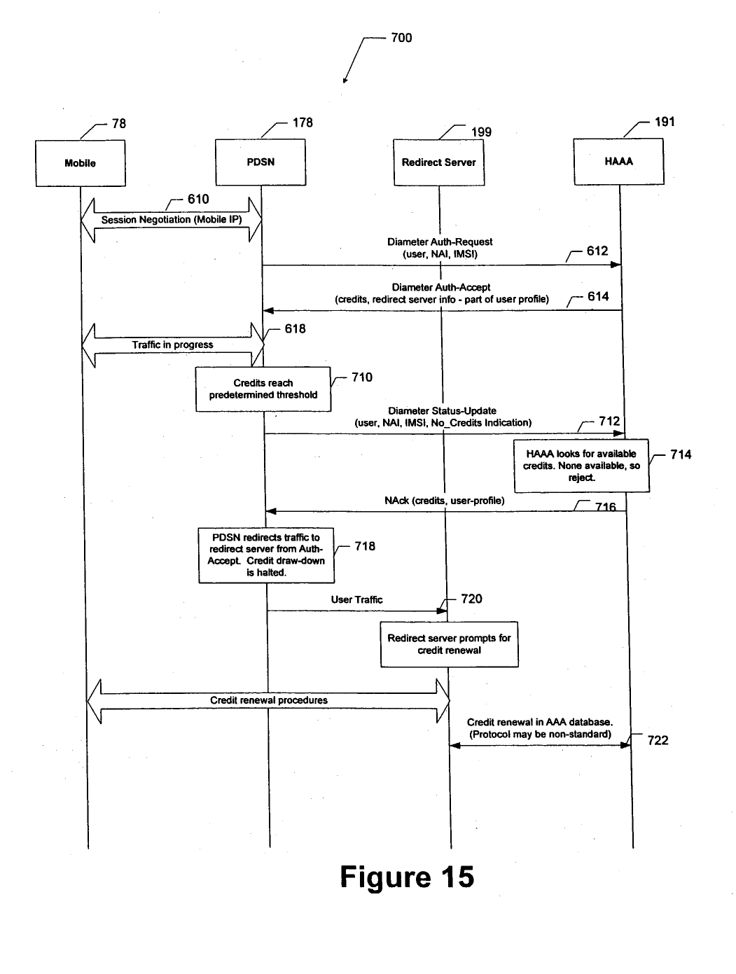

FIG. 15 is a call flow diagram illustrating an exemplary message flow 700 for redirecting a wireless prepaid call on network portion 169 of 3G network 108 using the DIAMETER protocol for purchasing credits for prepaid services in accordance with an exemplary embodiment. FIG. 15 shows the exemplary message flow 700, which is similar to the exemplary message flow 600, except as described herein. Referring now to FIG. 15, at 710, at some point the PDSN 178 runs out of credits. In response, the PDSN 178 sends to the HAAA 191 a DIAMETER Status-Update message 712 for acquiring more credits.

In order to ensure that the HAAA 191 and the PDSN 178 are in synchrony with respect to the credits used, the PDSN 178 may send regular status updates of usage. The frequency of the updates from the PDSN 178 to the HAAA 191 may be indicated by the AVP frequency parameter received with the DIAMETER Auth-Accept message 614 as indicated in the user profile, or alternatively, the frequency may be configured on the PDSN 178. The PDSN 178 may then update the HAAA 191 with the remaining credits on this frequency using DIAMETER Status-Update and corresponding DIAMETER NAck messages. Algorithms may be employed in the HAAA 191 to properly balance the credits used by the PDSN 178 against the available credits in the user profile. Alternatively, the HAAA 191 may request regular status updates from the PDSN 178 to track available credits, again, using DIAMETER Status-Update and corresponding DIAMETER NAck messages.

At 714, HAAA 191 queries the user profile (either locally or in a remote data store), and determines that no available credits exist. In response, HAAA 191 sends to the PDSN 178 an DIAMETER NAck message 716, which contains the lack of credit information, user profile information, and the identification of the Redirect Server 199 for redirecting the PPP 45 session 182 activity and for purchasing additional credits.

The PDSN 178, at 718, may redirect user requests to Redirect Server 199. Additionally, the PDSN 178 may stop debiting usage of the redirected communication. As noted above, communication with Redirect Server 199 via Redirect Interface (RI) 207 may use an IP based communication protocol.

This IP based communication protocol may use AVPs for providing specific information. Like the DIAMETER protocol, transactions on the Redirect Interface (Ri) 207 may allow the user (via the wireless mobile node 78) to apply more credits to the user account, and may alternatively inform the user of remaining credits, with a warning of disconnection.

In an alternative, the PDSN 178 may receive from the Redirect Server 199 information or instructions for (i) permitting the user to continue using the prepaid wireless services until all credits are expended, or (ii) for disconnecting the user immediately. The information or instructions sent by the Redirect Server 199 to the PDSN 178 may likewise use AVPs (vendor-specific or otherwise).

At 720, PDSN 178 redirects the wireless communication session to Redirect Server 199. The Redirect Server 199 may apply a packet filter to the wireless communication session to “keep-alive” the wireless communication session during the process of purchasing credits. The process of purchasing more credits may be performed in substantially the same manner as described above with reference to FIGS. 8a, 8b, and 8c. Alternatively, the process of purchasing credits may be performed in a similar manner as described above with reference to FIGS. 8a, 8b, and 8c, wherein the messages for communications between the network devices conform to the DIAMETER protocol.

In such case, at 722, if user opts to purchase more credits to add to the cache of available credits, the Redirect Server 199 may communicate with to the HAAA 191 via a set of DIAMETER negotiations. Alternatively, communications between the Redirect Server 199 and the HAAA 191 may be sent according to non-standard, proprietary, and/or vendor-specific protocol. In another alternative, the Redirect Server 199 may have trust relationships with the HAAA 191. This relationship may be a secure, shared database containing the user profile information, which is commonly accessible by both the HAAA 191 and Redirect Server 199. Other relationships are possible as well.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the block diagrams. The claims should not be read as limited to the described order or elements unless stated to that effect. In addition, use of the term “means” in any claim is intended to invoke 35 U.S.C. §112, paragraph 6, and any claim without the word “means” is not so intended. Therefore, all embodiments that come within the scope and spirit of the following claims and equivalents thereto are claimed as the invention.

Preferred and alternative embodiments of the present invention have been illustrated and described. It will be understood, however, that changes and modifications may be made to the invention without deviating from its true spirit and scope, as defined by the following claims. For example, as describe above the network-access-control server has been generally describe as a single entity. In fact, those skilled in the art will readily recognize that this functionality could be provided through a variety of other mechanisms. For example, the network-access-control device may be distributed over multiple physical devices. As another example, these multiple physical devices could include separate devices for authorization and prepaid accounting functions.

What is claimed is:

1. A method for providing prepaid billing on a data network for wireless prepaid services, the method comprising:
a network-access device requesting from a network-access-control device network access for a wireless communication session,
responsive to the request for network access, the network-access device receiving from the network-access-control device a block of credits and at least one measurement-method parameter;
the network-access device establishing session activity for the wireless communication session;
the network-access device measuring usage of the session activity for the wireless communication session; and
the network-access device debiting the usage of the session activity for the wireless communication session from the block of credits.

2. The method of claim 1, wherein the network-access device contains a plurality of predetermined-measurement methods, and further comprising:
the network-access device selecting one of the predetermined-measurement methods in response to receiving the at least one measurement-method parameter.

3. The method of claim 1, wherein the at least one measurement-method parameter comprises an algorithm.

4. The method of claim 1, wherein the at least one measurement-method parameter comprises a conversion factor.

5. The method of claim 1, further comprising:
the network-access device terminating the session activity for the wireless communication session.

6. The method of claim 5, further comprising:
the network-access device receiving from the network-access-control device an indication to terminate the session activity for the wireless communication session.

7. The method of claim 1, further comprising:
the network-access device requesting from the network-access-control device a second block of credits;
responsive to the request for a second block of credits, the network-access device receiving from the network-access-control device the second block of credits; and
the network-access device debiting the usage of the session activity for the wireless communication session from the second block of credits.

8. The method of claim 7, further comprising:
responsive to the request for a second block of credits, the network-access device receiving from the network-access-control device the at least one measurement-method parameter.

9. The method of claim 7, wherein the step of the network-access device requesting from the network-access-control device a second block of credits is performed when a predetermined number of the block of credits remain.

10. The method of claim 1, further comprising:
the network-access device requesting from the network-access-control device a second block of credits;
responsive to the request for a second block of credits, the network-access device receiving from the network-access-control device a denial of the request for a second block of credits; and
the network-access device terminating the session activity of the wireless communication session when no credits remain.

11. The method of claim 10, wherein the step of the network-access device requesting from the network-access-control device a second block of credits is performed when a predetermined number of the block of credits remain.

12. The method of claim 1, further comprising:
responsive to an authorization to purchase credits, adding credits to a cache of available credits.

13. The method of claim 12, wherein the authorization to purchase of credits comprises:
the network-access device sending to a second-network-access-control device a confirmation to a request for charging the purchase of credits against a payments account.

14. The method of claim 13, wherein information indicative of the payments account is stored in a user profile that is accessible to the second-network-access-control device; and
wherein the request to allow the second-network-access-control device to charge the purchase of credits against a payments account comprises:
the network-access device receiving from the second-network-access-control device the information indicative of the payments account; and
the network-access device receiving from the second-network-access-control device a request to confirm charging the purchase of credits against the payments account associated with the information indicative of payments account.

15. The method of claim 14, wherein the payments account is a credit account, a debit account, a deposit account or other debitable bank account.

16. The method of claim 13, further comprising:
the network-access device requesting from the network-access-control device a second block of credits;
the network-access device receiving from the network-access-control device parameters indicative of adding credits to the cache of available credits;
responsive to the parameters indicative of adding credits to the cache of available credits, the network-access device establishing a second communication between a user and a second-network-access device for authorizing a purchase of credits.

17. The method of claim 16, wherein the parameters indicative of adding the credits to the cache of available credits comprise a denial to the request for a second block of credits.

18. The method of claim 16, wherein the parameters indicative of adding the credits to the cache of available credits comprise an indication of second-access-control device from which the user may purchase credits.

19. The method of claim 12, further comprising:
the network-access device sending to a second-network-access-control device information indicative of a payments account; and
the network-access device authorizing the second-network-access-control device to charge the purchase of credits against the payments account associated with the information indicative of payments account.

20. The method of claim 19, wherein the payments account is a credit account, a debit account, a deposit account, a checking account or other debitable bank account.

21. The method of claim 19, further comprising:
the network-access device requesting from the network-access-control device a second block of credits;
the network-access device receiving from the network-access-control device parameters indicative of adding credits to the cache of available credits; and
responsive to the parameters indicative of adding credits to the cache of available credits, the network-access device establishing a second communication between a user and a second-network-access device for authorizing a purchase of credits.

22. The method of claim 21, wherein the parameters indicative of adding the credits to the cache of available credits comprise a denial to the request for a second block of credits.

23. The method of claim 21, wherein the parameters indicative of adding the credits to the cache of available credits comprise an indication of second-access-control device from which the user may purchase credits.

24. The method of claim 19, further comprising:
establishing a second wireless communication between a user and the second-network-access device in response to a user initiation of an authorization to purchase of credits; and
the network-access device receiving from the user information indicative of the payments account and the authorization to charge the purchase of credits against the payments account associated with the information indicative of the payments account.

25. The method of claim 12, wherein the authorization to purchase of credits comprises:
a user sending to the second-network-access-control device a request for charging the purchase of credits against a payments account, wherein information indicative of the payments account is stored in a user profile that is accessible to the second-network-access-control device;
responsive to the request for charging the purchase of credits against a payments account, the user receiving from the second-access-control device a request to confirm the charge the purchase of credits against the payments account associated with the information stored in the user profile; and
the user sending to a second-network-access-control device a confirmation to the request to charge the purchase of credits against the payments account associated with the information stored in the user profile.

26. The method of claim 12, further comprising:
the cache of available credits falling below a predetermined level; and
responsive to the cache of available credits falling below a predetermined level, the network-access-control device sending to a second-network-access control device an authorization to purchase credits.

27. The method of claim 26, wherein the authorization to purchase credits comprises:
the network-access device receiving from the network-access-control device a request for user authorization to charge the purchase of credits against a payments account; and
responsive to a user authorization, the network-access device sending to the network-access-control device the user authorization to charge the purchase of credits against the payments account.

28. The method of claim 27, wherein information indicative of the payments account is stored in a user profile that is accessible to the network-access-control device, and wherein user authorization comprises:
the network-access device receiving from the network-access-control device the information indicative of the payments account and a request to confirm charging the payments account associated with the information stored in the user profile;
the network-access device sending to the user the information indicative of the payments account and the request to confirm charging the payments account associated with the information stored in the user profile; and
the network-access device receiving from the user a confirmation to the request to confirm charging the payments account associated with the information stored in the user profile.

29. The method of claim 26, wherein information indicative of the payments account is stored in a user profile that is accessible to the network-access-control device, and wherein the information indicative of the payments account comprises a record for automatic authorization to charge the purchase of credits against a payments account associated with the information stored in the user profile.

30. The method of claim 29, wherein the payments account is a credit account, a debit account, a deposit account or other debitable bank account.

31. A method for providing prepaid billing on a data network for wireless prepaid services, the method comprising:
a network-access-control device receiving from a network-access device a request for network access for a wireless communication session,
responsive to the request for network access, the network-access-control device sending to the network-access device a block of credits and at least one measurement-method parameter;
the network-access device establishing session activity for the wireless communication session;
the network-access device measuring usage of the session activity for the wireless communication session; and
the network-access device debiting the usage of the session activity for the wireless communication session from the block of credits.

32. The method of claim 31, wherein the network-access device contains a plurality of predetermined-measurement methods, and further comprising:
responsive to the network-access-control device sending to the network-access device the at least one measurement-method parameter, the network-access device selecting one of the predetermined-measurement methods.

33. The method of claim 31, wherein the at least one measurement-method parameter comprises an algorithm.

34. The method of claim 31, wherein the at least one measurement-method parameter comprises a conversion factor.

35. The method of claim 31, further comprising:
the network-access device terminating the session activity for the first communication.

36. The method of claim 35, further comprising:
the network-access-control device sending to the network-access device an indication to terminate the session activity.

37. The method of claim 31, further comprising:
the network-access-control device receiving from the network-access device a request for a second block of credits;
responsive to the request for a second block of credits, the network-access-control device sending to the network-access device the second block of credits; and
the network-access device debiting the usage of the session activity for the wireless communication session from the second block of credits.

38. The method of claim 37, further comprising:
responsive to the request for a second block of credits, the network-access-control device sending to the network-access device the at least one measurement-method parameter.

39. The method of claim 37, wherein the step of the network-access-control device receiving from the network-access device a request for a second block of credits is performed when a predetermined number of the block of credits remain.

40. The method of claim 31, further comprising:
the network-access-control device receiving from the network-access device a request for a second block of credits;
responsive to the request for a second block of credits, the network-access-control device sending to the network-access device a denial of the request for a second block of credits; and
the network-access device terminating the session activity of the first communication when no credits remain.

41. The method of claim 40, wherein the step of the network-access-control device receiving from the network-access-control device a request for a second block of credits is performed when a predetermined number of the block of credits remain.

42. The method of claim 41, further comprising:
responsive to an authorization to purchase credits, adding credits to a cache of available credits.

43. The method of claim 42, wherein the authorization to purchase of credits comprises:
a second-network-access-control device receiving form the network-access device a confirmation to a request for charging the purchase of credits against a payments account.

44. The method of claim 43, wherein information indicative of the payments account is stored in a user profile that is accessible to the second-network-access-control device; and
wherein the request to allow the second-network-access-control device to charge the purchase of credits against a payments account comprises:
the second-network-access-control device sending to the network-access device the information indicative of the payments account; and
the second-network-access-control device sending to the network-access device a request to confirm charging the purchase of credits against the payments account associated with the information indicative of payments account.

45. The method of claim 44, wherein the payments account is a credit account, a debit account, a deposit account or other debitable bank account.

46. The method of claim 43, further comprising:
the network-access-control device receiving from the network-access device a request for a second block of credits;
the network-access-control device sending to the network-access device parameters indicative of adding credits to the cache of available credits; and
responsive to the parameters indicative of adding credits to the cache of available credits, the network-access device establishing a second communication between a user and a second-network-access device for authorizing a purchase of credits, wherein after the user authorizes a purchase of credits, the credits will be added to the cache of available credits.

47. The method of claim 46, wherein the parameters indicative of adding the credits to the cache of available credits comprise a denial to the request for a second block of credits.

48. The method of claim 46, wherein the parameters indicative of adding the credits to the cache of available credits comprise an indication of second-access-control device from which the user may purchase credits.

49. The method of claim 42, further comprising:
a second-network-access-control device receiving from the network-access device information indicative of a payments account; and
the second-network-access-control device receiving from the network-access device an authorization to charge the purchase of credits against the payments account associated with the information indicative of payments account.

50. The method of claim 49, wherein the payments account is a credit account, a debit account, a deposit account, a checking account or other debitable bank account.

51. The method of claim 49, further comprising:
the network-access-control device receiving from the network-access device a request for a second block of credits;
the network-access-control device sending to the network-access device parameters indicative of adding credits to the cache of available credits; and
responsive to the parameters indicative of adding credits to the cache of available credits, the network-access device establishing a second communication between a user and the second-network-access device for authorizing a purchase of credits.

52. The method of claim 51, wherein the parameters indicative of adding the credits to the cache of available credits comprise a denial to the request for a second block of credits.

53. The method of claim 51, wherein the parameters indicative of adding the credits to the cache of available credits comprise an indication of second-access-control device from which the user may purchase credits.

54. The method of claim 49, further comprising:
establishing a second wireless communication between a user and the second-network-access device in response to a user initiation of an authorization of purchase of credits; and
the network-access device receiving from the user information indicative of the payments account and the authorization to charge the purchase of credits against the payments account associated with the information indicative of the payments account.

55. The method of claim 52, wherein the authorization to purchase of credits comprises:
a second-network-access-control device receiving from a user a request to charge the purchase of credits against a payments account, wherein information indicative of the payments account is stored in a user profile that is accessible to the second-network-access-control device;
responsive to the request to charge the purchase of credits against a payments account, the second-access-control device sending to the user a request to confirm charging the purchase of credits against the payments account associated with the information stored in the user profile; and
the second-network-access-control device receiving from the user a confirmation to the request to charge the purchase of credits against the payments account associated with the information stored in the user profile.

56. The method of claim 42, further comprising:
the cache of available credits falling below a predetermined level; and
responsive to the cache of available credits falling below a predetermined level, the network-access-control device sending to a second-network-access control device an authorization to purchase credits.

57. The method of claim 56, wherein the authorization to purchase credits comprises:
the network-access-control device sending to the network-access device a request for user authorization to charge the purchase of credits against a payments account; and
responsive to a user authorization, the network-access-control device receiving from the network-access device the user authorization to charge the purchase of credits against the payments account.

58. The method of claim 57, wherein information indicative of the payments account is stored in a user profile that is accessible to the network-access-control device, and wherein user authorization comprises:
the network-access-control device sending to the network-access device the information indicative of the payments account and a request to confirm charging the payments account associated with the information stored in the user profile;
the network-access device sending to the user the information indicative of the payments account and the request to confirm charging the payments account associated with the information stored in the user profile; and
the network-access device receiving from the user a confirmation to the request to confirm charging the payments account associated with the information stored in the user profile.

59. The method of claim 58, wherein information indicative of the payments account is stored in a user profile that is accessible to the network-access-control device, and wherein the information indicative of the payments account comprises a record for automatic authorization to charge the purchase of credits against a payments account associated with the information stored in the user profile.

60. The method of claim 59, wherein the payments account is a credit account, a debit account, a deposit account or other debitable bank account.

61. An apparatus for providing prepaid billing on a data network for wireless prepaid services comprising:
a network-access device;
a network-access-control device;
a block of credits; and
at least one measurement-method parameter, wherein the network-access device receives from the network-access-control device the block of credits and the at least one measurement-method parameter, wherein the network-access device establishes session activity for a wireless communication session, wherein the network-access device measures usage of the session activity for the wireless communication session; and wherein the network-access device debits the usage of the session activity for the wireless communication session from the block of credits.

62. The apparatus of claim 61, further comprising a second-network access control device for receiving an authorization to purchase credits, wherein the network-access device sends to the second-network-access-control device the authorization to purchase credits.

63. An apparatus for providing prepaid billing on a data network for wireless prepaid services comprising:
a network-access device;
a network-access-control device;
wherein the network-access-control device sends to the network-access device a block of credits and at least one measurement-method parameter, wherein the network-access device establishes session activity for a wireless communication session, wherein the network-access device measures usage of the session activity for the wireless communication session; and wherein the network-access device debits the usage of the session activity for the wireless communication session from the block of credits.

64. The apparatus of claim 63, further comprising a second-network access control device for receiving an authorization to purchase credits, wherein the network-access device sends to the second-network-access-control device the authorization to purchase credits.

65. A network-access device for use in a data network and with a network-access-control device, comprising:
network usage credits as received from the network-access-control device; and
at least one usage measurement-method parameter as at least identified by the network-access-control device;
and wherein the network-access device has at least a first mode of operation such that:
the network-access device establishes session activity for a wireless communication session;
the network-access device ascertains usage of the session activity for the wireless communication session; and
the network-access device modifies the network usage credits as a function, at least in part, of the usage of the session activity for the wireless communications session;
such that prepaid billing services are accommodated by the network-access device.

66. The network-access device of claim 65 wherein the network-access device has at least a second mode of operation such that:
the network-access device requests additional network usage credits; and
the network-access device receives additional network usage credits; and
wherein the network-access device modifies the additional network usage credits as a function, at least in part, of continued usage of the session activity for the wireless communications session.

67. The network-access device of claim 66 wherein the network-access device requests additional network usage credits when the network usage credits are sufficiently depleted.

68. The network-access device of claim 66 wherein the network-access device has at least a third mode of operation such that:
the network-access device terminates the session activity of the wireless communications session when the network usage credits are depleted to at least a predetermined level.

69. A network-access-control device for use in a data network and with a network-access device, comprising:
network usage credits; and
at least one usage measurement-method parameter;
and wherein the network-access-control device has at least a first mode of operation such that:
the network-access-control device provides at least a portion of the network usage credits to the network-access device in response to a request from the network-access device when the network-access device seeks to establish session activity for a wireless communication system for a system user that corresponds to the network usage credits;
the network-access-control device further providing at least an indication of the at least one usage measurement-method parameter to the network-access device such that the network-access device can monitor usage of the network usage credits as a function, at least in part, of the at least one usage measurement-method parameter.

70. The network-access-control device of claim 69 wherein the network-access-control device has at least a second mode of operation such that:
the network-access-control device provides at least an additional portion of the network usage credits to the network-access device in response to a request from the network-access device when the network-access device seeks to continue maintaining the session activity for the system user.
